(19) United States
(12) Patent Application Publication
(10) Pub. No.: US 2026/0291631 A1
(43) Pub. Date: Sep. 24, 2026

(54) METHODS ON ASSOCIATION OF APERIODIC SRS TRANSMISSION AND CROSS-LINK INTERFERENCE (CLI) MEASUREMENT IN SUBBAND NON-OVERLAPPING FULL DUPLEX (SBFD) SYSTEMS

(71) Applicant: InterDigital Patent Holdings, Inc., Wilmington, DE (US)

(72) Inventors: Nazli Khan Beigi, Longueuil (CA); Jonghyun Park, Syosset, NY (US); Paul Marinier, Brossard (CA); Moon IL Lee, Melville, NY (US)

(73) Assignee: InterDigital Patent Holdings, Inc., Wilmington, DE (US)

(21) Appl. No.: 19/477,836

(22) PCT Filed: May 9, 2024
(86) PCT No.: PCT/US2024/028527

§ 371 Date: Oct. 23, 2025

Related U.S. Application Data
(60) Provisional application No. 63/465,109, filed on May 9, 2023.

(51) Int. Cl. H04B 17/309; H04B 17/318; H04L 5/00; H04W 56/00; H04W 72/231

(52) U.S. Cl. CPC H04B 17/346; H04B 17/318; H04L 5/0051; H04W 56/0045; H04W 72/231

(57) ABSTRACT

A wireless transmit/receive unit (WTRU) may receive configuration information associated with sounding reference signal (SRS) resources. The WTRU may receive an indication to receive and/or measure an SRS transmission in an SRS resource of one or more SRS resources and/or may measure cross link interference (CLI). The SRS resource may be associated with a time. The WTRU may determine a timing offset associated with the SRS transmission. The WTRU may determine a time and/or a time window to receive the SRS transmission based on the time associated with the SRS resource and/or the timing offset. The WTRU may receive the SRS transmission based on the time and/or the time window. The SRS transmission may be transmitted by a second WTRU. The WTRU may perform measurements on the SRS transmission. The WTRU may send a message to a network node that includes an indication of the measurements.

### CROSS-REFERENCE TO RELATED APPLICATION

This application claims priority to U.S. Provisional Patent Application No. 63/465,109 filed on May 9, 2023, the entire contents of which are incorporated herein by reference.

### BACKGROUND

New Radio (NR) duplex operation may be implemented to improve time-division duplexing (TDD) operation by enhancing uplink (UL) coverage, improving capacity, reducing latency, and/or otherwise improving TDD operation. TDD may be based on splitting the time domain between the uplink and downlink. The feasibility of allowing full duplex, or more specifically, subband non-overlapping full duplex (SBFD) at the gNB within a TDD band may be provided, as described herein.

### SUMMARY

Systems, methods, and apparatuses provided herein may include association of aperiodic sounding reference signal (SRS) transmission and/or aperiodic channel state information (CSI) measurement at the victim wireless transmit/receive unit (WTRU), aperiodic SRS transmission at the aggressor WTRU, hierarchical SRS configuration and/or cross-link interference (CLI) measurement over one or more shared resources, and/or group SRS transmission from the one or more aggressor WTRUs over one or more shared resources.

A first wireless transmit/receive unit (WTRU) may receive configuration information associated with one or more sounding reference signal (SRS) resources. The first WTRU may receive an indication to receive and/or measure an SRS transmission in an SRS resource of one or more SRS resources and/or may measure cross link interference (CLI). The SRS resource may be associated with a time. The first WTRU may determine a timing offset associated with the SRS transmission. The first WTRU may determine a time or a time window to receive the SRS transmission, for example, based on the time associated with the SRS resource and/or the timing offset. The first WTRU may receive the SRS transmission, for example, based on the time and/or the time window. The SRS transmission may be transmitted by a second WTRU. The first WTRU may perform one or more measurements on the SRS transmission. The first WTRU may send a message to a network node. The message may include an indication of the one or more measurements.

The timing offset may be a timing advance (TA) for reception of the SRS transmission from the second WTRU that is separate from a TA that the WTRU uses for transmission of an uplink (UL) transmission. The timing offset may be a delta offset value. The delta offset value may indicate a number of TA instances with respect to the UL transmission TA value of the first WTRU. The one or more measurements may include WTRU-to-WTRU CLI based on the received SRS transmission. The WTRU-to-WTRU CLI may include SRS-reference signal received power (SRS-RSRP) and/or CLI-received signal strength indicator (CLI-RSSI) in UL and/or downlink (DL) subbands, respectively.

The first WTRU may receive SRS repetition information. The first WTRU may measure repeated SRS transmission based on the SRS repetition. The determination of the timing offset associated with the SRS transmission may be based on reception of the timing offset associated with the SRS transmission. The first WTRU may determine a second timing offset based on when the first WTRU receives the SRS transmission in the time window and the time of the SRS resource. The first WTRU may send a report to a network node. The report may include a measured cross-link interference (CLI) value and/or a second timing offset. Performing the one or more measurements may include the first WTRU performing one or more aperiodic measurements based on one or more aperiodic SRSs.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 depicts an example of subband non-overlapping full duplex (SBFD) configuration in time-division duplexing (TDD) framework.

FIG. 3 depicts an example of scheduled WTRUs in uplink (UL) and/or downlink (DL) subbands in an exemplary SBFD symbol.

FIG. 4 depicts an example of channel state interference-reference signal CSI-RS resource mapping, where the parameters may be examples.

FIG. 5 depicts an example of sounding reference signal (SRS) signals received from one or more aggressor wireless transmit/receive units (WTRUs) with one or more different timing advance offsets.

### DETAILED DESCRIPTION

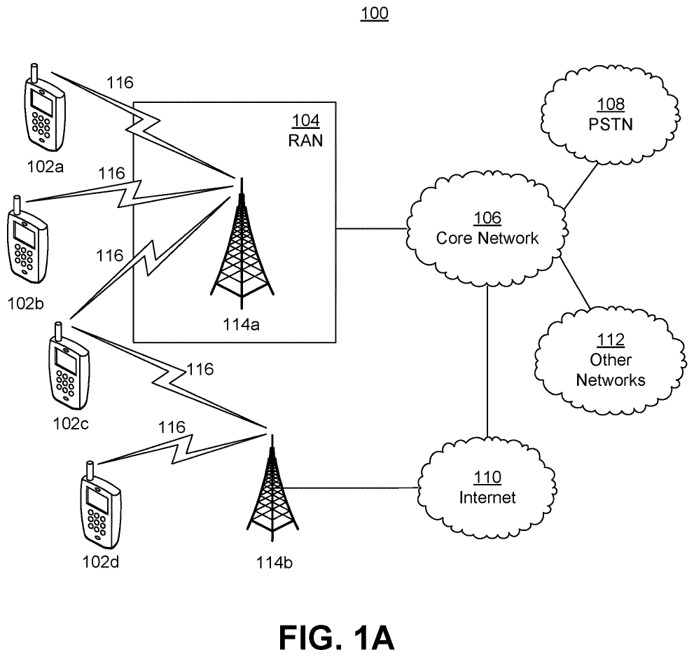

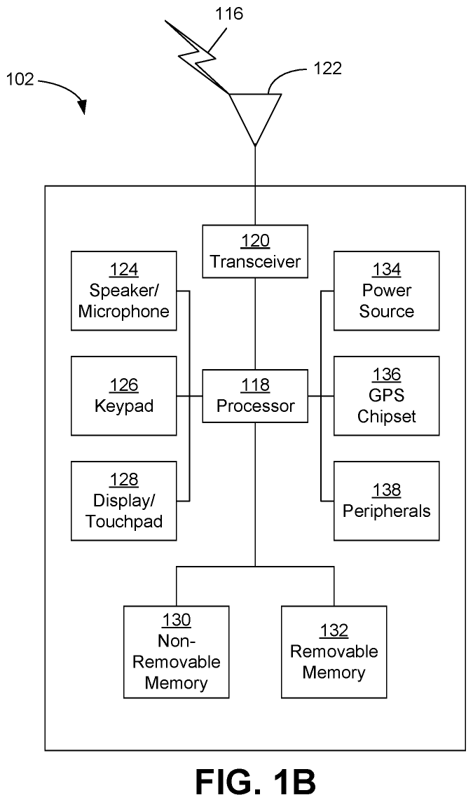

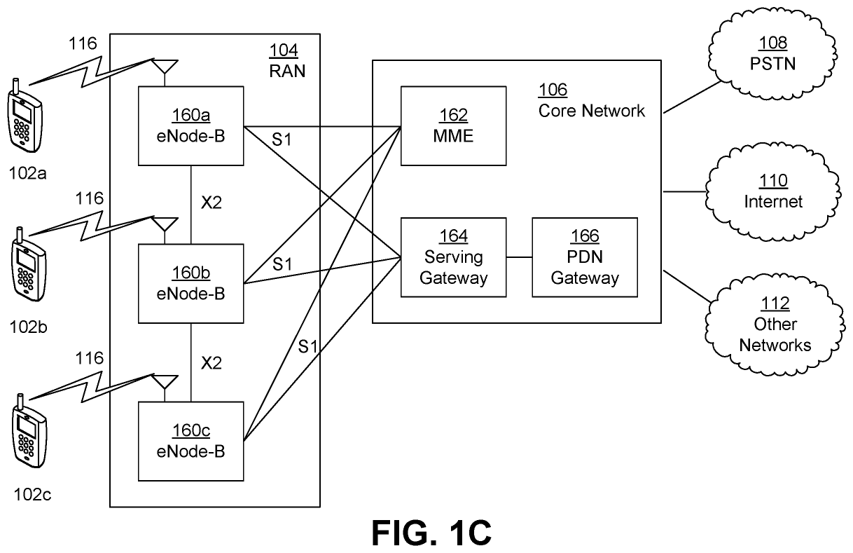

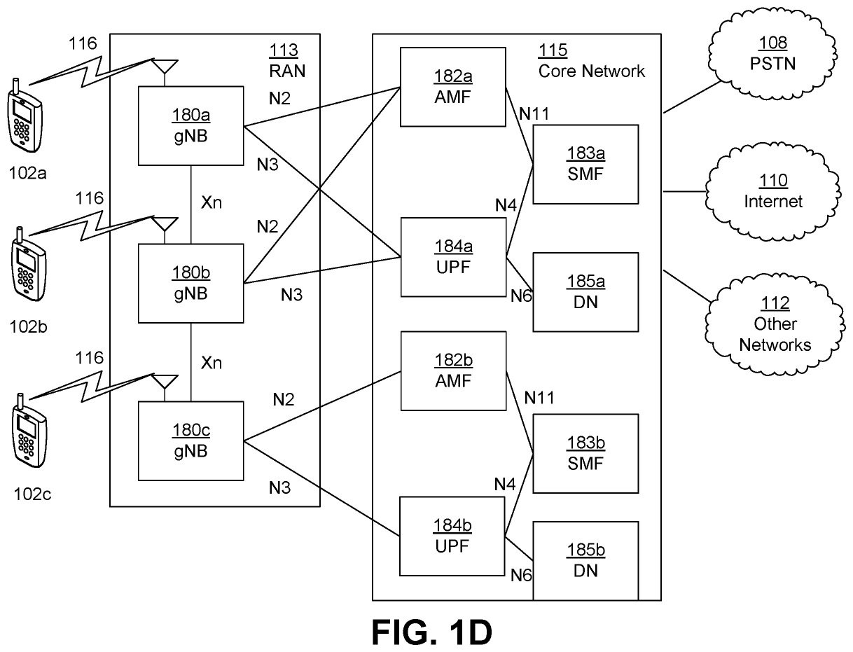

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUS 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANS, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAS that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHZ channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11 af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

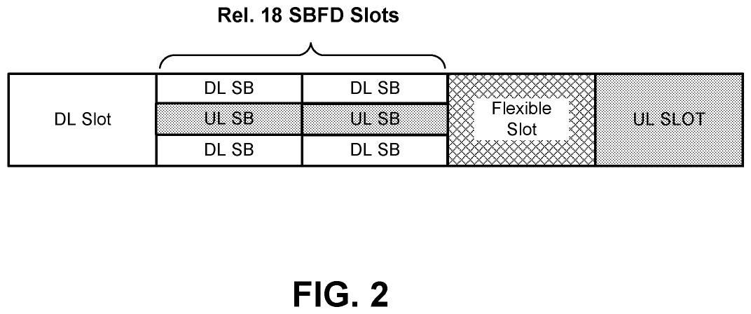

New Radio (NR) duplex operation may be included herein. NR duplex operation may improve time-division duplexing (TDD) operation by enhancing uplink (UL) coverage, improve capacity, reduce latency, and so forth. TDD may be based on splitting the time domain between the uplink and downlink. The feasibility of allowing full duplex, and/or subband non-overlapping full duplex (SBFD) at the gNB within a TDD band may be provided herein (e.g., FIG. 2).

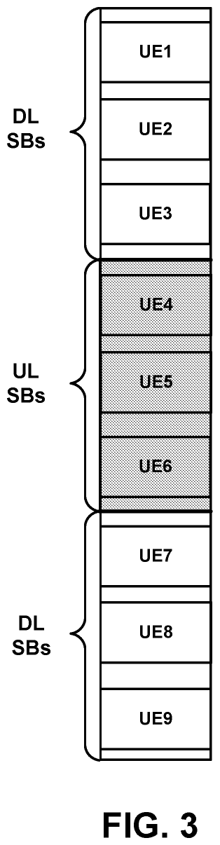

In TDD NR, cross-link interference-received signal strength indicator (CLI-RSSI) measurement and/or report may be based on using contiguous time and/or frequency resource for CLI-RSSI measurement. Additionally or alternatively, the WTRU may measure CLI-RSSI on the active downlink (DL) bandwidth part (BWP), which may have contiguous DL resources. In SBFD case, WTRU(s) that are indicated UL transmission in UL subband may cause WTRU-to-WTRU CLI to an intra-cell inter-WTRU(s), which tries to receive DL signal and/or channel in DL subbband. FIG. 3 depicts an example of scheduled different WTRUs in UL and/or DL subbands in an SBFD symbol.

Moreover, in TDD NR, a CSI report may not consider the impact of inter-WTRU CLI in the one or more reported metrics. Interference measurement may be (e.g., mainly) intra-cell cross beam interference and/or inter-cell DL interference. As an extension of reusing existing CSI framework, CSI report may include how to capture the impact of inter-WTRU CLI in the existing CSI reportQuantity and/or metrics including CSI feedback. For inter-WTRU inter-subband CLI measurement, the victim WTRU can measure at least one or more of the following: RSSI within DL subband, reference signal received power (RSRP) of the aggressor WTRU within UL subband, and/or RSSI within UL subband.

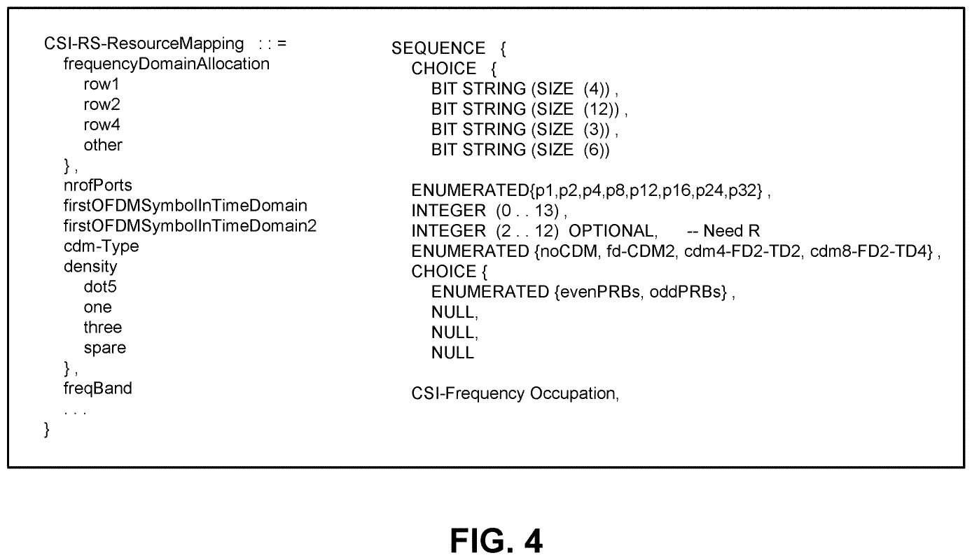

Measuring one-to-one CLI between the victim and the one or more aggressor WTRUs based on sounding reference signal (SRS) signaling may include one or more configurations on the frequency and/or timing (e.g., see FIG. 4), transmission power, repetition, etc. The indication of such configuration information to the victim and/or the one or more aggressor WTRUs may increase the overhead and/or latency. Therefore, enhancements on exchanging of configuration information in SBFD inter-WTRU inter-subband CLI measurement and/or reporting may be required.

Moreover, one-to-one CLI measurement between victim and one or more aggressor WTRUs based on SRS signaling may result in increased latency and/or usage of resources. In examples, the one-by-one SRS transmission, reception, measurement, and/or reporting may increase the latency to measure the inter-WTRU CLI. In examples, measuring the inter-WTRU CLI in configured resources may cause the WTRU to not perform transmission (Tx) and/or reception (Rx) in the one or more adjacent resources due to the strong CLI caused by the one or more aggressor WTRUs and/or one or more gNBs, resulting in waste of resources for one or more (e.g., each) CLI measurements based on SRS signaling. Thus, enhancements may be performed on the procedures to measure the CLI signal strength.

Systems, methods, and apparatuses provided herein may include configuration, measurement, and/or reporting for inter-WTRU inter-subband CLI based on SRS signaling in SBFD configurations.

Embodiments described herein relate to the association of aperiodic SRS transmission and/or (e.g., aperiodic) CSI measurement at the victim WTRU. A first WTRU (e.g., a potential victim WTRU) may receive configuration information on one or more reference signal (RS) resources. For example, the first WTRU may receive configuration information associated with one or more sounding reference signal (SRS) resources. The term SRS may be used interchangeably with RS. The RS resource configuration may include the reference signal's sequence, time and/or frequency resources (e.g., orthogonal frequency-division multiplexing (OFDM) symbol and/or subcarrier occupancy, etc.). The RS may be based on an SRS. The first WTRU may receive an indication (e.g., via DCI and/or MAC-control element (CE) to receive and/or measure an (e.g., one or more) SRS and/or measure an (e.g., aperiodic) CLI (e.g., SRS-RSRP) in each configured resource. For example, the first WTRU may receive an indication (e.g., trigger) to receive and/or measure an SRS transmission in an SRS resource of one or more SRS resources and/or may measure CLI. The SRS resource may be associated with a time. For example, the indications and/or triggers may be from gNB for CLI measurement at the first (e.g., victim) WTRU(s) for the purpose of scheduling. Additionally or alternatively, the trigger(s) may be from one or more higher layers due to measured and/or detected low SNR and/or high BLER.

The first WTRU may receive a timing offset (e.g., number of symbols and/or slots) dynamically (e.g., via DCI and/or MAC-CE) to apply when receiving and/or measuring the RS (e.g., SRS). For example, the first WTRU may receive and/or determine a timing offset associated with the SRS transmission. The determination of the timing offset associated with the SRS transmission may be, for example, based on reception of the timing offset associated with the SRS transmission. The WTRU may receive configuration, to determine the timing offset (e.g., timing advance offset (TAO), via downlink control information (DCI) and/or medium access control control element (MAC CE). For example, the WTRU may dynamically receive (e.g., via DCI and/or MAC CE indications) the (e.g., exact) value of TAO to be applied with respect to the configured starting time for receiving and/or measuring RS (e.g., SRS). The timing offset may be a timing advance (TA) for reception and/or may be separate and/or different from a timing advance the first WTRU may use for transmission. For example, the timing offset may be a TA for reception of the SRS transmission from the second WTRU that is separate from a TA that the first WTRU uses for transmission of an uplink (UL) transmission. The timing offset may be a delta offset value (e.g., ±n). For example, the timing offset may be associated with the number of timing advance instances with respect to first UE's configured transmission timing advance value. For example, the delta value may indicate one or more (e.g., a number of) TA instances with respect to the UL transmission TA value of the first WTRU.

The first WTRU may determine a time and/or time window to receive the RS (e.g., SRS), for example, based on the time of the configured resource and/or the timing offset. For example, the first WTRU may determine a time and/or a time window to receive the SRS transmission. For example, the time and/or time window may include one or more (e.g., a number of) symbols. The first WTRU may determine the time and/or the time window to receive the SRS transmission, for example, based on the time associated with the SRS resource and/or the timing offset.

The WTRU may receive configuration, to determine the timing offset, via downlink control information (DCI) and/or medium access control control element (MAC CE). For example, the WTRU may dynamically receive (e.g., via DCI and/or MAC CE indications) the (e.g., exact) value of TAO to be applied with respect to the configured starting time for receiving and/or measuring RS (e.g., SRS). The first WTRU may receive the SRS at or during the determined time and/or time window where the SRS may be transmitted by a second WTRU (e.g., aggressor WTRU). For example, the first WTRU may receive the SRS transmission based on the time and/or the time window. The SRS transmission may be transmitted by a second WTRU.

The first WTRU may measure WTRU-to-WTRU CLI, for example, based on the received SRS (e.g., SRS-RSRP and/or CLI-RSSI in UL and/or DL subbands, respectively). For example, the first WTRU may perform one or more measurements on the SRS transmission. The first WTRU may perform one or more aperiodic measurements based on one or more aperiodic SRSs. Reception of the timing offset may trigger the first WTRU to perform one or more measurements (e.g., aperiodic measurements). The one or more measurements may include WTRU-to-WTRU CLI based on the received SRS transmission. The WTRU-to-WTRU CLI may include SRS-reference signal received power (SRS-RSRP) and/or CLI-received signal strength indicator (CLI-RSSI) in UL and/or downlink (DL), respectively.

The first WTRU may measure and/or determine a second timing offset, for example, based on when the WTRU receives the SRS in the time window and/or the time of the configured resource. For example, the first WTRU may determine the second timing offset based on when the first WTRU receives the SRS transmission in the time window and/or the time of the SRS resource.

The first WTRU may report the measured CLI to the gNB and/or the second timing offset. For example, the first WTRU may send a message to a network node. The message may include an indication of the one or more measurements. For example, the first WTRU may send a report to a network node. The report may include a measured CLI value and/or a second timing offset.

Embodiments are described herein for providing repetition indication. The first WTRU may receive SRS repetition information. For example, the first WTRU may receive SRS repetition information (e.g., N) dynamically (e.g., via MAC-CE). The first WTRU may measure repeated SRS transmission (e.g., N, e.g., transmitted from the second WTRU). For example, the first WTRU may measure repeated SRS transmission based on the SRS repetition information.

Embodiments are described herein for providing resource indication. The first WTRU may receive the resources for SRS reception dynamically (e.g., via DCI, MAC-CE). For example, the first WTRU may be configured with candidate resources, where one candidate resource may be indicated dynamically (e.g., via DCI, MAC-CE) to be used for measuring the CLI. The first WTRU may monitor to receive the SRS within the configured resources. The configured resources for receiving and/or measuring SRS can be identified as non-zero-power (NZP), zero-power (ZP), and/or muted resources. The first WTRU may be measuring the effect of SRS (e.g., SRS-RSRP, SRS-CLI-RSSI) being transmitted in one or more other resources in the configured resources (e.g., WTRU measuring in DL subband (SB) based on the SRS transmitted in UL SB).

Embodiments described herein relate to handling aperiodic SRS transmission at the aggressor WTRU. A first WTRU (e.g., potential aggressor WTRU) may receive configuration (e.g., including time and/or frequency resources in its serving cell) for one or more aperiodic SRS transmissions (e.g., in UL SB in SBFD configuration). For example, the first WTRU may receive configuration information associated with one or more SRS transmissions. For example, a first WTRU may receive configuration for one or more aperiodic SRS transmissions for CLI measurement at a second WTRU (e.g., potential victim WTRU).

Embodiments are described herein with respect to a timing advance (TA). The first WTRU may receive an indication indicating what cell (e.g., and/or whether to use its serving cell and/or a different cell) to use as the reference for timing and/or timing advance for an SRS transmission using resources of its serving cell. For example, the first WTRU may receive an indication indicating a serving cell of a second WTRU to be used to determine a timing and/or a timing advance of an SRS transmission. The indication may be based on radio resource control (RRC) indication of a set of resources (e.g., for the serving cell and/or another cell). For example, the first WTRU may receive the indication via a RRC indication of a set of resources. The first WTRU may receive the indication via DCI and/or MAC CE. For example, the first WTRU may receive indication via DCI/MAC-CE for selection from the set. The first WTRU may determine a time for the SRS transmission based on the indication. For example, the first WTRU may determine a time to be used for the SRS transmission based on the same serving cell or a different/non-serving cell. Based on the same serving cell (e.g., in the case the victim WTRU and the aggressor WTRU are in the same cell), the first WTRU may determine the time to transmit the SRS based on its serving cell's DL timing (e.g., plus timing advance information and/or commands (received from the gNB)). For example, upon a determination that the serving cell of the second WTRU is the same serving cell of the first WTRU, the first WTRU may determine the time to transmit the SRS transmission based on a DL timing of the serving cell.

The timing advance may be a first type of timing advance that the first WTRU uses for transmission of UL signals and/or channels (e.g., physical uplink control channel (PUCCH), physical uplink shared channel (PUSCH), SRS, etc.), and/or the timing advance may be a second type of timing advance that the first WTRU uses for the transmission of SRS to be measured by the second WTRU. The first WTRU may receive the configuration on the timing advance (e.g., via RRC, MAC-CE, and/or DCI). Based on a different/non-serving cells (e.g., in case the victim WTRU and aggressor WTRU are not in the same cell) the first WTRU may determine to transmit the SRS based on the indicated cell's DL reference timing (e.g., plus timing advance information (received from gNB)). For example, upon a determination that the serving cell of the second WTRU is a neighboring cell of the first WTRU, the first WTRU may determine the time to transmit the SRS transmission based on a DL timing of the neighboring cell. Upon a determination that the serving cell of the second WTRU is a neighboring cell of the first WTRU, the first WTRU may measure one or more DL RSs from the neighboring cell to determine the DL timing. The timing advance may be a first type of timing advance that the first WTRU uses for transmission of UL signals and/or UL channels (e.g., PUCCH, PUSCH, SRS, etc.), and/or the timing advance may be a second type of timing advance that the first WTRU uses for the transmission of SRS to be measured by the second WTRU. For example, the first WTRU may send the SRS transmission, based on the second timing advance, to be measured by a second WTRU. The timing advance for the cases with different/non-serving cells may be similar or different from the timing advance that the first WTRU may use for transmission in the same serving cell. The WTRU may receive the configuration on the timing advance (e.g., via RRC, MAC-CE, and/or DCI).

The first WTRU may measure one or more configured/indicated DL RS (e.g., SSB, CSI-RS, etc.) from the indicated cell to determine the DL timing, e.g., for the purpose of this type of aperiodic SRS transmission. The first WTRU may transmit SRS (e.g., using resources of its serving cell) using the determined DL timing and/or timing advance. For example, the first WTRU may send the SRS transmission based on the determined time to transmit the SRS transmission. For example, the first WTRU may determine the time to transmit the SRS transmission based on the timing advance that the first WTRU uses for UL transmissions in the serving cell of the first WTRU.

The first WTRU may be configured with first SRS resource(s) within the UL SB and/or second SRS resource(s) outside of the UL SB (e.g., inside a DL SB) (e.g., of an SBFD slot or other time unit). The first WTRU may determine a power adjustment to apply and/or whether to apply a power adjustment to the SRS transmission, for example, based on whether the SRS transmission resource(s) is/are within an UL SB and/or a DL SB (e.g., first SRS resource or second SRS resources, respectively), and in case the SRS transmission resource is within an UL SB, how close it is to a boundary of the UL SB. For example, the first WTRU may determine a power adjustment to apply to the SRS transmission based on whether the SRS transmission resources are within an UL SB or a DL SB, and/or based on one or more power control (PC) related parameters. In examples, the first WTRU may receive configuration of one or more power adjustment (e.g., backoff) values. For example, the first WTRU may receive one or more power adjustment values. The power adjustment values may be included in the one or more adjustment values. For example, when the SRS transmission resource(s) may be in the first SRS resources (e.g., UL SB), the first WTRU may perform transmission of the SRS without applying the one or more power adjustment values. The first WTRU may send the SRS transmission without applying the one or more adjustment values; the SRS transmission resources may be included within an UL SB. For example, when the SRS transmission resource(s) (e.g., one or more of the SRS transmission resources) is in the second SRS resources (e.g., DL SB), the first WTRU may transmit the SRS applying a power adjustment to the transmission power where the power adjustment (e.g., from the configured power adjustments) is determined based on one or more of: a frequency (e.g., resource block (RB)) distance between a boundary of the UL SB and a reference RB of the SRS resource; and/or a minimum frequency (e.g., RB) distance between a boundary of the UL SB and an RB of the SRS resource. For example, the first WTRU may send the SRS transmission based on one or more of: a frequency distance between a boundary of the UL SB and a reference RB of a SRS resource or a minimum frequency distance between a boundary of the UL SB and a RB of the SRS resource; the SRS transmission resources may be included within a DL SB.

Embodiments described herein may relate to hierarchical SRS configuration and/or CLI measurement over one or more shared resources. A first WTRU may receive configuration information that includes an indication that the first WTRU is to measure one or more CLI measurements in time and/or frequency resources associated with one or more (e.g., a plurality) of SRS transmissions. For example, the first WTRU (e.g., victim WTRU) may receive configuration to measure and/or report CLI (e.g., SRS-CLI-RSSI). For example, the first WTRU may receive configuration to measure and/or report CLI in a DL SB. The CLI measurements may include SRS-CLI-RSRP measurements and/or SRS-CLI-RSSI measurements. The configuration may include the time and/or frequency resources where one or more SRS transmissions (e.g., from one or more second (aggressor) WTRUs) using one or more sequences may be received and/or measured by the first WTRU.

The one or more SRS transmissions using one or more sequences may be received and/or measured by the first WTRU at the same (e.g., and/or overlapping) time and/or frequency resources (e.g., group-SRS-transmission). For example, the one or more (e.g., multiple) different SRS sequences may be transmitted to the first WTRU by one or more other WTRUs. The CLI (e.g., SRS-CLI-RSSI) measurement and/or reporting may be periodic, semi-persistent, and/or aperiodic. The first WTRU may receive configuration information indicating the one or more SRS sequences associated with the CLI (e.g., SRS-CLI-RSSI) measurement. For example, the configuration information may include an indication of one or more SRS sequences for the CLI measurements. For example, the first WTRU may receive the sequences used for SRS transmission via an index or indices in a MAC-CE and/or DCI to select from an RRC configured list. The SRS sequence may include an index and/or an identification (ID).

The first WTRU may perform one or more CLI measurements of the time and/or frequency resources. For example, the first WTRU may measure CLI (e.g., SRS-CLI-RSSI) in one or more of the configured time and frequency resources. For example, performing the one or more CLI measurements may include measuring the plurality of SRS transmissions in the same time resource and/or same frequency resources. For example, the first WTRU may perform an energy (e.g., and/or power) level measurement on the time and frequency resources. To perform the CLI measurements, the first WTRU may perform an energy level measurement and/or power level measurement on the time and frequency resources. For example, when two or more different SRS sequences are used (e.g., transmitted by a second and third WTRU), the first WTRU may derive the SRS-CLI-RSSI, for example, based on performing one or more measurements with one or more different SRS sequences and/or combining the one or more measurements using a pre-defined and/or pre-configured function. When one or more (e.g., multiple) different SRS sequences are used, for example, the first WTRU may determine the CLI measurements based on performing measurements with different SRS sequences and/or combining the measurements using a pre-defined and/or pre-configured function.

The first WTRU may compare the one or more CLI measurements to a threshold. The first WTRU may send an indication of the one or more CLI measurements. For example, if the measured CLI (e.g., SRS-CLI-RSSI) is higher than a first threshold and/or two or more different SRS sequences are used, the first WTRU may perform one or more of the following. For example, upon a determination that a measured CLI measurement of the one or more CLI measurements is greater than the threshold and a plurality of SRS sequences are used during the time and frequency resources, the first WTRU may determine an SRS sequence out of the plurality of SRS sequences and perform one or more of the following: send an indication of the SRS sequence, send a CLI associated with the SRS sequence, or send an indication of the one or more CLI measurements. The first WTRU may determine (e.g., and/or may attempt to determine) an SRS sequence among the SRS sequences (e.g., the SRS sequence with the highest CLI or one above a configured second threshold, the SRS sequence with the highest SRS-RSRP and/or SRS sequence with a SRS-RSRP above a configured third threshold). The first WTRU may report (e.g., if an SRS sequence is determined) one or more of: the determined SRS sequence (e.g., index or ID), the corresponding CLI, and/or the corresponding SRS-RSRP. The first WTRU may report the CLI measurement (e.g., SRS-CLI-RSSI). Upon a determination that a measured CLI measurement of the one or more CLI measurements is less than the threshold, the first WTRU may send an indication of the measured CLI measurements. For example, if the measured CLI (e.g., SRS-CLI-RSSI) is below the first threshold, the first WTRU may report the CLI (e.g., SRS-CLI-RSSI). Upon a determination that a measured CLI measurement of the one or more CLI measurements is greater than a threshold and a single SRS sequence was used during the time and frequency resources, and/or upon a determination that the first WTRU is unable to determine an SRS sequence among the plurality of SRS sequences, the first WTRU may perform one or more of the following: send an indication of one or more CLI (e.g., SRS-CLI-RSSI) measurements and/or send a request to a network node to provide the WTRU with another (e.g., new) measurement configuration with one or more SRS sequences and/or different SRS sequences. For example, if the measured CLI (e.g., SRS-CLI-RSSI) is higher than a first threshold and (e.g., only) one SRS sequence is used and/or if the first WTRU is unable to determine an SRS sequence among the SRS sequences, for example, the first WTRU may perform one or more of the following. The first WTRU may report the measured CLI (e.g., SRS-CLI-RSSI). The first WTRU may send a request to the gNB to provide the WTRU with a (e.g., new) measurement configuration with one or more (e.g., multiple) and/or different SRS sequences.

With respect to a beam, for example, a WTRU may transmit and/or receive a physical channel and/or reference signal according to one or more spatial domain filters. A beam may be used to refer to a spatial domain filter.

The WTRU may transmit a physical channel and/or signal using the same spatial domain filter as the spatial domain filter used for receiving an RS (such as CSI-RS) and/or a synchronization signal (SS) block. The WTRU transmission may be referred to as a target, and/or the received RS and/or SS block may be referred to as a reference or source. In examples, the WTRU may be said to transmit the target physical channel and/or signal according to a spatial relation with a reference to such RS and/or SS block.

The WTRU may transmit a first physical channel and/or signal according to the same spatial domain filter as the spatial domain filter used for transmitting a second physical channel and/or signal. The first and second transmissions may be referred to as target and reference or source, respectively. In examples, the WTRU may transmit the first (e.g., target) physical channel and/or signal according to a spatial relation with a reference to the second (e.g., reference) physical channel and/or signal.

A spatial relation may be implicit, configured by RRC and/or signaled by MAC CE and/or DCI. For example, a WTRU may implicitly transmit PUSCH and/or demodulation reference signal (DM-RS) of PUSCH according to the same spatial domain filter as an SRS indicated by an SRS resource indicator (SRI) indicated in DCI and/or configured by RRC. In examples, a spatial relation may be configured by RRC for an SRI and/or signaled by MAC CE for a PUCCH. Such spatial relation may also, or alternatively, be referred to as a beam indication.

The WTRU may receive a first (e.g., target) downlink channel and/or signal according to the same spatial domain filter and/or spatial reception parameter as a second (e.g., reference) downlink channel and/or signal. For example, such association may exist between a physical channel such as PDCCH and/or PDSCH and its respective DM-RS. At least when the first and/or second signals are reference signals, for example, such association may exist when the WTRU is configured with a quasi-colocation (QCL) assumption type D between corresponding antenna ports. Such association may be configured as a transmission configuration indicator (TCI) state. A WTRU may be indicated an association between a CSI-RS and/or SS block and a DM-RS by an index to a set of TCI states configured by RRC and/or signaled by MAC CE. Such indication may also, or alternatively, be referred to as a beam indication.

A transmission and/or reception point (TRP) may be interchangeably used with one or more of: transmission point (TP), reception point (RP), radio remote head (RRH), distributed antenna (DA), base station (BS), a sector (e.g., of a BS), and/or a cell (e.g., a geographical cell area served by a BS). Multi-TRP may be interchangeably used with one or more of: MTRP, M-TRP, and/or multiple TRPs.

A subband or sub-band may be used to refer to a frequency-domain resource and/or may include one or more of the following: a set of resource blocks (RBs); a set of resource block sets (RB sets), e.g., when a carrier has intra-cell guard bands; a set of interlaced resource blocks; a bandwidth part (e.g., or portion thereof); and/or a carrier (e.g., or portion thereof). For example, a subband may include a starting RB and/or number of RBs for a set of contiguous RBs within a bandwidth part. Additionally or alternatively, a subband may include the value of a frequency-domain resource allocation field and/or bandwidth part index.

The XDD may refer to a subband-wise duplex (e.g., either UL or DL being used per subband) and/or may include one or more of the following: Cross Division Duplex (e.g., subband-wise frequency division duplexing (FDD) within a TDD band); Subband non-overlapping full duplex (SBFD); Subband-based full duplex (e.g., full duplex as both UL and DL are used/mixed on a symbol and/or slot, but either UL or DL being used per subband on the symbol/slot); Frequency-domain multiplexing (FDM) of DL and/or UL transmissions within a TDD spectrum; A subband non-overlapping full duplex (e.g., non-overlapped sub-band full-duplex); A full duplex other than a same-frequency (e.g., spectrum sharing, subband-wise-overlapped) full duplex; and/or an advanced duplex method, e.g., other than (pure) TDD and/or FDD.

The terms dynamic TDD and/or flexible TDD may be used to refer to a TDD system/cell which may dynamically (e.g., and/or flexibly) change and/or adjust and/or switch a communication direction (e.g., a downlink, an uplink, and/or a sidelink, etc.) on a time instance (e.g., slot, symbol, subframe, and/or the like). In examples, in a system employing dynamic and/or flexible TDD, a component carrier (CC) and/or a bandwidth part (BWP) may have one single type among ‘D’, ‘U’, and/or ‘F’ on a symbol and/or slot, based on an indication by a group-common (GC)-DCI (e.g., format 2_0) comprising a slot format indicator (SFI), and/or based on tdd-UL-DL-config-common/dedicated configurations. On a given time instance/slot/symbol, for example, a first gNB (e.g., cell, TRP) employing dynamic/flexible TDD may transmit a downlink signal to a first WTRU being communicated/associated with the first gNB based on a first SFI and/or tdd-UL-DL-config configured/indicated by the first gNB. A second gNB (e.g., cell, TRP) employing dynamic/flexible TDD may receive an uplink signal transmitted from a second WTRU being communicated/associated with the second gNB based on a second SFI and/or tdd-UL-DL-config configured/indicated by the second gNB. In examples, the first WTRU may determine that the reception of the downlink signal is being interfered by the uplink signal, where the interference caused by the uplink signal may refer to a WTRU-to-WTRU cross-layer interference (CLI).

A WTRU may report a subset of channel state information (CSI) components, where one or more CSI components may correspond to one or more of: a CSI-RS resource indicator (CRI), a synchronization signal/physical broadcast channel (SS/PBCH) block (SSB) resource indicator (SSBRI), an indication of a panel used for reception at the WTRU (e.g., a panel identity and/or group identity), one or more measurements such as L1-RSRP, L1-signal-to-noise interference ratio (SINR) taken from SSB and/or CSI-RS (e.g., cri-RSRP, cri-SINR, ssb-Index-RSRP, ssb-Index-SINR), and/or one or more other channel state information such as at least rank indicator (RI), channel quality indicator (CQI), precoding matrix indicator (PMI), Layer Index (LI), and/or the like.

A WTRU may perform channel and/or interference measurements. A WTRU may receive a SSB. The SSB may include a primary synchronization signal (PSS), secondary synchronization signal (SSS), and/or physical broadcast channel (PBCH). The WTRU may monitor, receive, and/or attempt to decode an SSB during initial access, initial synchronization, radio link monitoring (RLM), cell search, cell switching, and/or the like.

A WTRU may measure and/or report the channel state information (CSI), where the CSI for one or more (e.g., each) connection modes may include and/or be configured with one or more of the following: CSI report configuration, CSI-RS resource set, and/or NZP CSI-RS resources. CSI report configuration may include one or more of the following: CSI report quantity (e.g., Channel Quality Indicator (CQI), Rank Indicator (RI), Precoding Matrix Indicator (PMI), CSI-RS Resource Indicator (CRI), Layer Indicator (LI), etc.); CSI report type (e.g., aperiodic, semi persistent, periodic); CSI report codebook configuration (e.g., Type I, Type II, Type II port selection, etc.); and/or CSI report frequency. CSI-RS resource set may include one or more of the following CSI resource settings: NZP-CSI-RS Resource for channel measurement; NZP-CSI-RS Resource for interference measurement; and/or CSI-IM Resource for interference measurement. NZP CSI-RS resources may include one or more of the following: NZP CSI-RS Resource ID; periodicity and/or offset; QCL Information and/or TCI-state; and/or resource mapping (e.g., number of ports, density, CDM type, etc.)

A WTRU may indicate, determine, and/or be configured with one or more reference signals. The WTRU may monitor, receive, and/or measure one or more parameters, for example, based on the respective reference signals. For example, one or more of the following may apply. The following parameters may be non-limiting examples of the parameters that may be included in reference signal(s) measurements. One or more of the parameters provided herein may be included. Other parameters may be included.

SS-reference signal received power (RSRP) (SS-RSRP) may be included in reference signal(s) measurements. SS-RSRP may be measured based on the synchronization signals (e.g., demodulation reference signal (DMRS) in PBCH or SSS). SS-RSRP may be the linear average over the power contribution of the resource elements (RE) that carry the respective synchronization signal. In measuring the RSRP, power scaling for the reference signals may be included. In case SS-RSRP is used for L1-RSRP, for example, the measurement may be accomplished based on CSI reference signals in addition to the synchronization signals.

CSI-RSRP may be included in reference signal(s) measurements. CSI-RSRP may be measured based on the linear average over the power contribution of the resource elements (RE) that carry the respective CSI-RS. The CSI-RSRP measurement may be configured within measurement resources for the configured CSI-RS occasions.

SS-SINR may be included in reference signal(s) measurements. SS-SINR may be measured based on the synchronization signals (e.g., DMRS in PBCH and/or SSS). SS-SINR may be the linear average over the power contribution of the resource elements (RE) that carry the respective synchronization signal divided by the linear average of the noise and interference power contribution. In case SS-SINR is used for L1-SINR, for example, the noise and/or interference power measurement may be accomplished based on resources configured by one or more higher layers.

CSI-SINR may be included in reference signal(s) measurements. CSI-SINR may be measured based on the linear average over the power contribution of the resource elements (RE) that carry the respective CSI-RS divided by the linear average of the noise and interference power contribution. In case CSI-SINR is used for L1-SINR, for example, the noise and/or interference power measurement may be accomplished based on one or more resources configured by one or more higher layers. Otherwise, the noise and/or interference power may be measured based on the resources that carry the respective CSI-RS, for example.

RSSI may be included in reference signal(s) measurements. RSSI may be measured based on the average of the total power contribution in configured OFDM symbols and/or bandwidth. The power contribution may be received from one or more different resources (e.g., co-channel serving and/or non-serving cells, adjacent channel interference, thermal noise, and/or so forth).

CLI-RSSI may be included in reference signal(s) measurements. CLI-RSSI may be measured based on the average of the total power contribution in configured OFDM symbols of the configured time and/or frequency resources. The power contribution may be received from one or more different resources (e.g., cross-layer interference, co-channel serving and/or non-serving cells, adjacent channel interference, thermal noise, and/or so forth).

SRS-RSRP may be included in reference signal(s) measurements. SRS-RSRP may be measured based on the linear average over the power contribution of the resource elements (RE) that carry the respective SRS.

SS-RSRQ may be included in reference signal(s) measurements. Secondary synchronization signal (SS) reference signal received quality (RSRQ) (SS-RSRQ) may be measured based on one or more measurements on the reference signal received power (SS-RSRP) and/or received signal strength (RSSI). In examples, the SS-RSRQ may be calculated as the ratio of NxSS-RSRP/NR carrier RSSI, where N may be determined based on the number of resource blocks that are in the corresponding NR carrier RSSI measurement bandwidth. As such, the measurements to be used in the numerator and/or denominator may be over the same set of resource blocks.

CSI-RSRQ may be included in reference signal(s) measurements. CSI-RSRQ may be measured based on one or more measurements on the reference signal received power (CSI-RSRP) and/or received signal strength (RSSI). In examples, the SS-RSRQ may be calculated as the ratio of NxCSI-RSRP/CSIRSSI, where N may be determined based on the number of resource blocks that are in the corresponding CSI-RSSI measurement bandwidth. As such, the measurements to be used in the numerator and/or denominator may be over the same set of resource blocks.

A property of a grant and/or assignment may include one or more of: a frequency allocation; an aspect of time allocation, such as a duration; a priority; a modulation and/or coding scheme; a transport block size; one or more (e.g., a number of) spatial layers; one or more (e.g., a number of) transport blocks; a TCI state, CRI and/or SRI; one or more (e.g., a number of) repetitions; whether the repetition scheme is Type A or Type B; whether the grant may be a configured grant type 1, type 2 and/or a dynamic grant; whether the assignment may be a dynamic assignment and/or a semi-persistent scheduling (e.g., configured) assignment; a configured grant index and/or a semi-persistent assignment index; a periodicity of a configured grant and/or assignment; a channel access priority class (CAPC); and/or one or more (e.g., any) parameters provided in a DCI, by MAC and/or by RRC for the scheduling the grant and/or assignment.

An indication by DCI may include one or more of the following: an explicit indication by a DCI field and/or by RNTI used to mask and/or scramble the CRC of the DCI; and/or an implicit indication by a property such as DCI format, DCI size, Coreset or search space, Aggregation Level, and/or first resource element of the received DCI (e.g., index of first Control Channel Element), where the mapping between the property and the value may be signaled by RRC and/or MAC. Receiving and/or monitoring for a DCI with and/or using an RNTI may mean that the CRC of the DCI is masked and/or scrambled with the RNTI.

A signal may be interchangeably used with one or more of following: sounding reference signal (SRS); channel state information-reference signal (CSI-RS); demodulation reference signal (DM-RS); phase tracking reference signal (PT-RS); and/or synchronization signal block (SSB).

A channel may be interchangeably used with one or more of following: Physical downlink control channel (PDCCH); Physical downlink shared channel (PDSCH); Physical uplink control channel (PUCCH); Physical uplink shared channel (PUSCH); Physical random access channel (PRACH); and/or the like.

Downlink reception may be used interchangeably with Rx occasion, PDCCH, PDSCH, and/or SSB reception. Uplink transmission may be used interchangeably with Tx occasion, PUCCH, PUSCH, PRACH, and/or SRS transmission.

RS may be used interchangeably used with one or more of RS resource, RS resource set, RS port, and/or RS port group. RS may be interchangeably used with one or more of SSB, CSI-RS, SRS, and/or DM-RS.

The terms time instance, slot, symbol, and/or subframe may be used interchangeably herein.

The terms UL-only and DL-only Tx/Rx occasions may interchangeably be used with (e.g., legacy) TDD UL or (e.g., legacy) TDD DL, respectively. In examples, the (e.g., legacy) TDD UL/DL Tx/Rx occasions may be the cases where SBFD is not configured and/or where SBFD is disabled.

The terms received signal power, received signal energy, received signal strength, SSB energy per resource element (EPRE), CSI EPRE, RSRP, RSSI, SINR, RSRQ, SS-RSRP, SS-RSSI, SS-SINR, SS-RSRQ, CSI-RSRP, CSI-RSSI, CSI-SINR, and CSI-RSRQ may be used interchangeably herein.

The inter-WTRU inter SB CLI measurement and/or reporting at the victim WTRU based on SRS reception from the aggressor WTRUs with SBFD operation may be considered herein. Systems, methods, and apparatuses described herein may be used for one or more (e.g., any kind of) interference measurement and/or reporting, for example, based on one or more (e.g., any) reference signals in one or more (e.g., any) modes of operation.

Herein, the term CLI may be used interchangeably with interference. Herein, the term non-SBFD may be used interchangeably with operation without SBFD, and/or TDD (e.g., legacy) TDD.

Herein, the terms ‘WTRU may be configured’, ‘WTRU may be indicated’, ‘WTRU may receive configuration’, and/or so forth, may imply that the configuration is indicated, for example, ‘via RRC, MAC-CE, DCI, MIB, SIB, and/or so forth’, unless indicated otherwise. For example, ‘WTRU may be configured’ may imply ‘WTRU may be configured via RRC, MAC-CE, MIB, SIB, and/or so forth’.

The terms victim WTRU and/or aggressor WTRU may be used herein. One or more (e.g., any kind of) WTRUs may be associated with (e.g., perform) the methods, systems, and apparatuses described herein.

With respect to subband non-overlapping full duplex (SBFD), for example, a WTRU may be configured with one or more types of slots within a bandwidth, where a first type of slot may be used and/or determined for a first direction (e.g., downlink); a second type of slot may be used and/or determined for a second direction (e.g., uplink); a third type of slot may have a first group of frequency resources within the bandwidth for a first direction and/or a second group of frequency resources within the bandwidth for a second direction. The bandwidth may be interchangeably used herein with bandwidth part (BWP), carrier, subband, and/or system bandwidth. The first type of slot (e.g., the slot for a first direction) may be referred to herein as downlink slot. The second type of slot (e.g., slot for a second direction) may be referred to herein as uplink slot. The third type of slot may be referred to herein as Sub-Band (non-overlapping) Full Duplex (SBFD) slot. The group of frequency resource for a first direction may be referred to herein as downlink subband, downlink frequency resource, and/or downlink RBs. The group of frequency resource for a second direction may be referred to herein as uplink subband, uplink frequency resource, and/or uplink RBs.

In examples, a (SBFD-enabled) WTRU may receive and/or be configured with one or more SBFD UL and/or DL subbands in one or more DL and/or UL and/or flexible TDD time instances (e.g., symbols, slots, frames, and so forth). The WTRU may be configured with one or more resource allocations for SBFD subbands. For example, the SBFD configuration may include a flag signal (e.g., enabled/disabled), where, for example, a first value (e.g., zero (0)) may indicate a first mode of operation (e.g., SBFD configuration), and/or a second value (e.g., one (1)) may indicate a second mode of operation (e.g., non-SBFD operation). The modes of operation (e.g., SBFD vs. non-SBFD) may be indicated via MIB, SIB, semi-statically (e.g., via RRC), dynamic (e.g., via MAC-CE, DCI), and/or so forth. The WTRU may receive the time resources (e.g., one or more symbols, slots, and so forth). For example, the WTRU may be configured to use and/or apply the first mode of operation (e.g., SBFD) in one or more BWPs, subbands, component carriers (CCs), cells, and/or the like. The WTRU may receive the frequency resources (e.g., subbands/BWPs including one or more physical resource blocks (PRBs) within (e.g., active and/or linked) BWP, for which the first mode of operation (e.g., SBFD) is configured. The time instances (e.g., slots, symbols) may be indicated based on periodic, semi-persistent, and/or aperiodic configurations. In examples, the time instances may be indicated via a bitmap configuration.

In examples, a WTRU may be configured with a DL TDD configuration for a component carrier (CC) and/or a BWP for one or more Rx occasions (e.g., via tdd-UL-DL-config-common/dedicated configurations, slot format indicator (SFI), and so forth). As such, if the first mode of operation (e.g., SBFD) is configured, for example, one or more of the configured frequency resources (e.g., subbands, PRBs, and/or BWPs) may be configured for the transmission in UL channels and/or Tx occasions.

In examples, the WTRU may be configured with an UL TDD configuration for a component carrier (CC) and/or a BWP for one or more Tx occasions (e.g., via tdd-UL-DL-config-common/dedicated configurations, slot format indicator (SFI), and so forth). As such, if the first mode of operation (e.g., SBFD) is configured, for example, one or more of the configured frequency resources (e.g., subbands, PRBs, and/or BWPs) may be configured as the DL channels and/or Rx occasions.

In examples, the WTRU may be configured with a DL, UL, and/or Flexible TDD configuration for a component carrier (CC) and/or a BWP for one or more Rx/Tx occasions (e.g., via tdd-UL-DL-config-common/dedicated configurations, slot format indicator (SFI), and so forth). As such, if the first mode of operation (e.g., SBFD) is configured, for example, one or more of the configured frequency resources (e.g., subbands, PRBs, and/or BWPs) may be configured for the first mode of operation (e.g., either UL transmission and/or DL reception based on the configurations).

The duplexing mode for the first mode of operation (e.g., SBFD configuration (UL/DL)) may be indicated via a flag indication, where for example a first value (e.g., zero (0)) may indicate a first mode (e.g., UL duplexing mode), and a second the value (e.g., one (1) may indicate a second mode (e.g., DL duplexing model).

The duplexing mode configuration and/or flag for the first mode of operation (e.g., SBFD) may be configured as part of modes of operation configuration that can be semi-static (e.g., via RRC) or dynamic (e.g., via DCI, MAC-CE).

The duplexing mode configuration and/or flag for the first mode of operation (e.g., SBFD) may be configured as part of resource allocation configuration for a Tx/Rx occasion.

With respect to CLI measurement, for example, a WTRU may be configured, determined, and/or indicated to perform a measurement of cross-link interference (CLI) Received Signal Strength Indicator (RSSI) in a given time period, where the given time period may be one or more slots, OFDM symbols, resource blocks (RBs), and/or resource elements (REs). The CLI-RSSI, which may be measured in a given time/frequency resource, may be referred to as L1-CLI-RSSI, short-term CLI-RSSI, aperiodic CLI-RSSI, and/or the like. Additionally or alternatively, the WTRU may be configured, determined, and/or indicated to perform a measurement of Reference Signal Received Power (RSRP), for example, based on one or more reference signals (e.g., SRS-RSRP) in the context of CLI measurement in a given time period, where the given time period may be one or more slots, OFDM symbols, resource blocks (RBs), and/or resource elements (REs). The SRS-RSRP, which may be measured in a given time/frequency resource, may be referred to as L1-SRS-RSRP, short-term SRS-RSRP, aperiodic SRS-RSRP, SRS-RSRP-CLI, and/or the like. CLI-RSSI, L1-CLI-RSSI, and RSSI may be interchangeably used herein. SRS-RSRP, SRS-RSRP-CLI, L1-SRS-RSRP, and RSRP may be interchangeably used herein. One or more RSSI (e.g., or RSRP) types may be used and a WTRU may be configured to perform one or more RSSI (or RSRP) types, where a first RSSI (e.g., or RSRP) type may be based on a measurement over a long time period (e.g., more than one slot) and/or the measurement may be reported via a higher layer signaling (e.g., RRC, MAC); a second RSSI (or RSRP) type may be based on a measurement over a short time period (e.g., one slot, within a slot, one or more OFDM symbols within a slot) and/or the measurement may reported via a layer one (L1) signaling (e.g., PUCCH, PUSCH, RACH, SRS). RSSI may be interchangeably used herein with RSRP, RSRQ, and/or SINR. CLI-RSSI may be interchangeably used herein with SRS-RSRP and/or SINR. The WTRU may be configured with a set of time/frequency resource to measure L1-CLI-RSSI, where the time/frequency resource for L1-CLI-RSSI measurement may be referred to as CLI-RSSI Measurement Resource (CRMR).

CRMR may be a resource configured, determined, and/or defined (e.g., via RRC, MAC-CE, DCI) (e.g., via CLI-ResourceConfig, CLI-ResourceConfig-r-16, and so forth) with one or more of following properties. CRMR may include a set of muted REs in downlink resource (e.g., PDSCH), where the muted REs may be rate-matched around and/or punctured for downlink reception and/or uplink transmission. The set of muted REs may have a same pattern (e.g., same time/frequency location) in each RB. The set of muted REs may have a different pattern based on the RB location. For example, a first pattern may be used for the RBs located in an edge of the scheduled RBs and/or a second pattern may be used for the RBs located in a center of the scheduled RBs. The first pattern and/or the second pattern may have a different number of muted RES. The muted REs may be in a form of zero-power resources (e.g., CSI-RS and/or ZP-CSI-RS). CRMR may include a set of REs not scheduled and/or used for the WTRU measuring CRMR. CRMR may include a set of REs that may be located in an RB which may be configured and/or determined as guard band (e.g., or guard RB). A guard band (or guard RB) may be located in between uplink and downlink resources. A WTRU may skip receiving and/or transmitting a signal in guard band. CRMR may include one or more reference signals (e.g., DMRS, SRS, sidelink CSI-RS, etc.). A second set of DMrS REs within a second CDM group (e.g., within a scheduled downlink resource/RBs, e.g., of PDSCH), where a WTRU may receive a DCI, scheduling the PDSCH, indicating a first set of DMrS REs corresponding to a first CDM group to be used for receiving the PDSCH. In an example, the WTRU may receive the DCI, scheduling the PDSCH, indicating a first set of DMrS REs corresponding to a first CDM group (based on an indicated ‘(DMRS) antenna port’ field of the DCI. In response to receiving the DCI, the WTRU may determine that a second set of DMrS REs within a second CDM group (other than the first CDM group) may be used as the CRMR (e.g., within the scheduled PDSCH). CRMR may be located within a scheduled resource (e.g., scheduled PDSCH RBs).

CRMR may be configured (e.g., commonly) for a set of WTRUs (e.g., WTRUs in proximity). For example, a gNB may configure a CRMR for a group of WTRUs, where the group of WTRUs may share one or more of following: a group-ID to receive a DCI (e.g., a group-RNTI); a zone-ID, where the zone-ID may be determined based on a geographical location of the WTRU (e.g., global navigation satellite system (GNSS)); and/or WTRUs paired for sidelink unicast (e.g., or groupcast) transmission.

In examples, L1-CLI-RSSI measurement (e.g., including CRMR resource) may be considered as CSI reporting quantity and configured as a part of CSI reporting setting.

CRMR may be configured in a first subband type (e.g., DL subbands) to measure the (e.g., effect of) one or more reference signals received in a second subband type (e.g., UL subbands). As such, for example, the reference signals may be received and/or measured in one or more resources that can be identified as zero-power and/or muted resources. The WTRU may be configured, determined, and/or indicated to measure the effect of one or more reference signals being transmitted in other resources (e.g., second type resources, UL subbands) in one or more resources (e.g., first type resources, DL subbands, etc.). For example, a first WTRU may be configured to measure SRS-RSRP in DL subbands on an SBFD configuration, where the SRS may be transmitted by a second WTRU in the UL subbands. In examples, the first WTRU may measure SRS-RSRP based of the configured SRS signaling in the DL subbands. In examples, the WTRU may measure the CLI-RSSI based on the configured SRS signaling in the UL subbands.

The WTRU may be configured, determined, and/or indicated to perform a delta CLI-RSSI, which may be based on a first CLI-RSSI measurement in a first time/frequency location and/or a second CLI-RSSI measurement in a second time/frequency location. One or more of the following may apply. The delta CLI-RSSI (delta-CLI-RSSI) may be a difference between a first CLI-RSSI (e.g., CLI-RSSI1) and a second CLI-RSSI (e.g., CLI-RSSI2), e.g., delta-CLI-RSSI=CLI-RSSI₁−CL-RSSI₂ (e.g., and/or delta-CLI-RSSI=CLI-RSSI₂−CL-RSSI₁, etc.). The first CLI-RSSI may be measured from CRMR resources located in the edge of the scheduled RBs, while the second CLI-RSSI may be measured from CRMR resources located in the middle of the scheduled RBs. A WTRU may be configured with a first CRMR resource for the first CLI-RSSI measurement and/or a second CRMR resource for the second CLI-RSSI measurement. A WTRU may determine to report CLI measurement related information, for example, when a measured delta-CLI-RSSI is larger than a threshold. For example, CLI reporting may be triggered based on when the delta-CLI-RSSI measurement is larger than a threshold, where the threshold may be predetermined and/or configured.

The WTRU may be configured and/or determined to measure CLI-RSSI per subband level. For example, a subband may be configured, and/or predetermined and/or a WTRU may perform CLI-RSSI measurement in one or more (e.g., each) subband. One or more of following may apply. The Subband size may be determined based on the number of scheduled RBs (e.g., for PDSCH). The WTRU may report CLI-RSSI measurement for each subband. The WTRU may report a subset of CLI-RSSI, where the subset may be determined based on one or more conditions (e.g., CLI-RSSI value above threshold, subband location (e.g., edge of scheduled RBs), and/or subband index).

The WTRU may determine a bandwidth of beam measurement and/or reporting (e.g., wideband or subband) based on one or more of following conditions: time unit type (e.g., SBFD or non-SBFD) and/or presence of CLI-RSSI measurement. For example, a WTRU may report wideband CRI (e.g., wideband beam index) in non-SBFD time units (e.g., symbol, slot, and/or the like) and/or the WTRU may report subband CRI (e.g., subband beam index) in one or more SBFD time units. Presence of CLI-RSSI measurement may include the bandwidth of beam measurement and/or reporting is determined based on whether CLI-RSSI is measured in the same slot or not.

The WTRU may be indicated to perform CLI-RSSI measurement in a specific frequency location within a scheduled RBs (e.g., or non-scheduled RBs), where the specific frequency location may be one or more of subbands, RBs, and/or REs. The indication may be in a DCI which may trigger the CLI-RSSI measurement (e.g., aperiodic CLI-RSSI measurement). The specific frequency location may be indicated based on the CRMR resource frequency location. For example, one or more CRMR resources may be configured and/or each CRMR resource may be located in a (e.g., specific) frequency location based on configuration. The WTRU may be indicated to perform measurement on CRMR resource indicated in a DCI.

Embodiments are described herein for association of aperiodic RS (e.g., SRS) transmission and/or (e.g., aperiodic) CSI measurement (e.g., at the victim WTRU). A WTRU (e.g., first WTRU) may perform one or more of the following. A first WTRU (e.g., a potential victim WTRU) may receive configuration information on one or more reference signal (RS) resources. For example, the first WTRU may receive configuration information associated with one or more SRS resources. The RS resource configuration may include the reference signal's sequence, time and/or frequency resources (e.g., OFDM symbol and/or subcarrier occupancy, etc.). The RS may be based on an SRS. The first WTRU may receive an indication and/or trigger (e.g., via DCI and/or MAC-CE) to receive and/or measure one or more SRSs and/or measure an (e.g., aperiodic) CLI (e.g., SRS-RSRP) in each configured resource. For example, the first WTRU may receive an indication and/or trigger to receive and/or measure an SRS transmission in an SRS resource of one or more SRS resources and/or may measure CLI. The SRS resource may be associated with a time.

The first WTRU may receive a timing offset (e.g., number of symbols and/or slots) dynamically (e.g., via DCI and/or MAC-CE) to apply when receiving and/or measuring the RS (e.g., SRS). For example, the first WTRU may receive and/or determine a timing offset associated with the SRS transmission. The determination of the timing offset associated with the SRS transmission may be, for example, based on reception of the timing offset associated with the SRS transmission. The WTRU may receive configuration, to determine the timing offset, via downlink control information (DCI) and/or medium access control control element (MAC CE). For example, the WTRU may dynamically receive (e.g., via DCI and/or MAC CE indications) the (e.g., exact) value of TAO to be applied with respect to the configured starting time for receiving and/or measuring RS (e.g., SRS). The timing offset may be a TA for reception and/or may be separate and/or different from a timing advance the first WTRU may use for transmission. For example, the timing offset may be a TA for reception of the SRS transmission from the second WTRU that is separate from a TA that the first WTRU uses for transmission of an UL transmission. The timing offset may be a delta offset value (e.g., ±n). For example, the timing offset may be associated with the number of timing advance instances with respect to first UE's configured transmission timing advance value. For example, the delta value may indicate one or more (e.g., a number of) TA instances with respect to the UL transmission TA value of the first WTRU.

The first WTRU may determine a time and/or time window to receive the RS (e.g., SRS), for example, based on the time of the configured resource and/or the timing offset. For example, the first WTRU may determine a time and/or time window to receive the SRS transmission. For example, the time and/or time window may include one or more (e.g., a number of) symbols. The first WTRU may determine the time and/or the time window to receive the SRS transmission, for example, based on the time associated with the SRS resource and/or the timing offset.

The first WTRU may receive the RS (e.g., SRS) at or during the determined time and/or time window where the RS (e.g., SRS) may be transmitted by a second WTRU (e.g., aggressor WTRU). For example, the first WTRU may receive the SRS transmission based on the time and/or the time window. The SRS transmission may be transmitted by a second WTRU.

The first WTRU may measure WTRU-to-WTRU CLI, for example, based on the received SRS (e.g., SRS-RSRP and/or CLI-RSSI in UL and/or DL subbands, respectively). For example, the first WTRU may perform one or more measurements on the SRS transmission. The first WTRU may perform one or more aperiodic measurements based on one or more aperiodic SRSs. Reception of the timing offset may trigger the first WTRU to perform one or more measurements (e.g., aperiodic measurements). The one or more measurements may include WTRU-to-WTRU CLI based on the received SRS transmission. The WTRU-to-WTRU CLI may include SRS-RSRP and/or CLI-RSSI in UL and/or DL, respectively. The first WTRU may measure and/or determine a second timing offset, for example, based on when the WTRU receives the RS (e.g., SRS) in the time window and/or the time of the configured resource. For example, the first WTRU may determine the second timing offset based on when the first WTRU receives the SRS transmission in the time window and/or the time of the SRS resource. The first WTRU may report the measured CLI to the gNB and/or the second timing offset. For example, the first WTRU may send a message to a network node. The message may include an indication of the one or more measurements. For example, the first WTRU may send a report to a network node. The report may include a measured CLI value and/or a second timing offset. Though embodiments may be described herein with respect to SRS, for example, RS may be used interchangeably herein with SRS.

The first WTRU may receive RS (e.g., SRS) repetition information (e.g., N) dynamically (e.g., via MAC-CE). The first WTRU may measure repeated RS (e.g., SRS) transmission (e.g., N, e.g., transmitted from the second WTRU).

The first WTRU may receive the resources for RS (e.g., SRS) reception dynamically (e.g., via DCI, MAC-CE). For example, the first WTRU may be configured with candidate resources, where one candidate resource may be indicated dynamically (e.g., via DCI, MAC-CE) to be used for measuring the CLI. The first WTRU may monitor to receive the RS (e.g., SRS) within the configured resources. The configured resources for receiving and/or measuring RS (e.g., SRS) can be identified as non-zero-power (NZP), zero-power (ZP), and/or muted resources. The first WTRU may be measuring the effect of SRS (e.g., SRS-RSRP, SRS-CLI-RSSI) being transmitted in one or more other resources in the configured resources (e.g., WTRU measuring in DL subband (SB) based on the SRS transmitted in UL SB).

A WTRU may receive one or more configurations (e.g., via RRC) on measurement and/or reporting of one or more reference signals (e.g., CSI-RS). The WTRU may receive one or more report configurations (e.g., via RRC, e.g., CSI-ReportConfig). The report configuration may include one or more of the following non-limiting parameters and/or choices: Carrier; measurement resources; report quantity; report type; report frequency configuration; codebook configuration; and/or the like. Carrier may include, for example, the cell and/or the carrier the report is sent to. Measurement resources may include, for example, the resources (e.g., CSI) that are used for channel and/or interference measurement (e.g., resourcesForChannelMeasurement, csi-IM-ResourcesForInterference, nzp-CSI-RS-ResourcesForInterference, and so forth, e.g., via CSI-ResourceConfig). Report quantity may include, for example, the quantities to be reported (e.g., CRI, precoding matrix indicator (PMI), rank indicator (RI), CQI, layer indicator (LI), RSRP, and so forth). Report type may include, for example, periodic, semi-persistent, and/or aperiodic, including periodicity, slot offset (e.g., reportSlotConfig), resources to send the report (e.g., PUCCH and/or PUSCH resources, e.g., via pucch-CSI-ResourceList and/or reportSlotOffsetList, respectively). Report frequency configuration may include, for example, if the measurement and/or reporting of the configured reference signal is based on subband and/or wideband, and/or the subband size in frequency domain (e.g., reportFreqConfiguration, subbandSize, and/or the like). Codebook configuration may include, for example, codebook configuration for Type-1 and/or Type-2 including codebook subset restriction (e.g., codebookConfig).

The WTRU may receive one or more configurations on the list of resource sets (e.g., CSI-RS resource set list) to be measured (e.g., via RRC, e.g., via CSI-ResourceConfig). The resource set list configurations may include a list of references to (e.g., CSI-RS) resources used for measuring parameters on the channel, interference, beam, and/or the like. For example, the resource set list configuration may include a list of references to one or more of the following, which is a non-limiting example of the reference lists and/or resource lists. One or more of those reference lists and/or resource lists may be included. Other reference lists, resource lists, and/or choices may be included. A NZP-CSI-RS resource set may be included. For example, a NZP-CSI-RS resource set may include a list of references to NZP CSI-RS resources used for beam, channel, and/or interference measurement and/or reporting in a CSI-RS resource set (e.g., via nzp-CSI-RS-ResourceSetList). A CSI SSB resource set may be included. For example, a CSI SSB resource set may include a list of references to SSB resources used for beam, channel, and/or interference measurement and/or reporting in a CSI-RS resource set (e.g., via csi-SSB-ResourceSetList). A CSI-IM resource set may be included. A CSI-IM resource set may include, for example, a list of references to CSI-IM resources used for beam and/or interference measurement and/or reporting in a CSI-RS resource set (e.g., via csi-IM-ResourceSetList). A ZP-CSI-RS resource set may be included. A ZP-CSI-RS resource set may include, for example, a list of references to ZP CSI-RS resources used for channel and/or interference measurement and reporting in a CSI-RS resource set (e.g., via zp-CSI-RS-ResourceSetList). A resource set time-domain types may be included. For example, a resource set time-domain types may include time domain behavior of resource configuration (e.g., periodic, semi-persistent, and/or aperiodic).

The WTRU may receive one or more configurations on the time and/or frequency mappings (e.g., CSI-RS-ResourceMapping) for one or more of the configured resources set lists (e.g., CSI-ResourceConfig as described herein). In examples, the WTRU may receive configuration on the resource mapping for one or more reference signals and/or resources (e.g., NZP-CSI-RS-Resources, ZP-CSI-RS-Resources, and/or the like). For example, the first WTRU may receive configuration information associated with one or more SRS resources. For instance, the resource mapping may indicate the sequence generated and/or used for the reference signal. In examples, the resource mapping may include the time and/or frequency resources, for example, indicating OFDM symbol and/or subcarrier occupancy of the CSI-RS resource within a slot, and/or the like. FIG. 4 depicts an example of reference signals' resource mapping. FIG. 4 depicts a non-limiting example of the parameters. One or more of the parameters (e.g., depicted in FIG. 4) may be included. For example, the number of bits and/or choices for one or more (e.g., each) parameter may be included. One or more other numbers of bits and/or choices may be included.

If the CLI measurement (e.g., SRS-RSRP, CLI-RSSI, etc.) could be considered similar to CSI reporting quantity and/or configured as a part of CSI reporting setting, for example, the application and/or implication can be improved (e.g., along with one or more enhancements that are considered for CSI measurements and/or reporting). Systems, methods, and apparatuses provided herein may address how a WTRU measures SRS RSRP and/or CLI-RSSI in the context of CSI measurement and/or reporting. CSI-RS resource sets may be used interchangeably herein with CSI-RS resources.

A WTRU may be configured with one or more reference signals that are associated with one or more sequences. For example, the first WTRU may receive configuration information association with one or more SRS resources. For example, the sequence may be based on SRS (e.g., Zadoff-Chu sequences). The WTRU may receive configuration (e.g., via RRC, MAC-CE, DCI) on one or more CSI-RS resource sets, including CSI resource settings (e.g., NZP-CSI-RS resources), where the reference signal's sequence may be based on a first RS type (e.g., CSI-RS, e.g., pseudo random sequence), a second RS type (e.g., SRS, e.g., Zadoff-chu sequences), and/or the like.

The WTRU may be configured, determined, and/or indicated (e.g., via RRC, MAC-CE, DCI) to use the configured reference signal (e.g., SRS) for measuring the channel and/or interference parameters (e.g., SRS-RSRP, CLI-RSSI, etc.).

In examples, the WTRU may receive an indication to a table and/or list to determine the one or more parameters to be used for generating and/or determining the configured RS (e.g., sequence) based on a first RS (e.g., CSI-RS, e.g., pseudo random sequence). In examples, the WTRU may receive one or more indications on parameters (e.g., root index, cyclic shift, etc.) to be used for generating and/or determining the configured RS (e.g., sequence) based on a second RS (e.g., SRS, e.g., Zadoff-Chu sequence).

A WTRU may measure one or more reference signals on DL, UL, flexible TDD, and/or guardbands.

In examples, a WTRU may be configured, determined, and/or indicated (e.g., via RRC, MAC-CE, DCI) to measure one or more reference signals in one or more frequency domain resources, where the reference signal may be received in the same or different and/or separate frequency domain resources.

A WTRU may perform one or more measurements on the same frequency resources as the received RS. In examples, a WTRU may be configured, determined, and/or indicated (e.g., via RRC, MAC-CE, DCI) to measure one or more reference signals in one or more frequency domain resources, where the reference signal is received in the same frequency domain resources. In examples, the WTRU may measure reference signals in one or more types of frequency domain resources. For example, a WTRU may measure reference signals in a first type of frequency domain resources (e.g., UL subbands, RBs, BWPs, etc.), in a second type of frequency resources (e.g., DL subbands, RBs, BWPs, etc.), in a third type of frequency resources (e.g., Flexible subbands, RBs, BWPs, etc.), in a fourth type of frequency resources (e.g., guardbands), and/or the like.

The WTRU may receive configuration (e.g., via RRC, MAC-CE, DCI) on one or more CSI-RS resource sets, including CSI resource settings to be NZP-CSI-RS resources, ZP-CSI-RS resources, CSI-IM resources, and/or the like. In examples, if the CSI resource setting is set to NZP-CSI-RS resources, the WTRU may use the measured parameters based on the configured reference signal for channel and/or interference measurements, calculations, and/or estimations (e.g., RSRP, SINR, RSRQ, CLI, etc.). In examples, if the CSI resource setting is set to ZP-CSI-RS resources, the WTRU may use the measured parameters based on the configured resources for interference measurements, calculations, and/or estimations (e.g., SINR, CQI, RSRQ, CLI, etc.). In examples, if the CSI resource setting is set to CSI-IM resources, the WTRU may use the measured parameters based on the configured reference signals and/or resources for interference measurements, calculations, and/or estimations (e.g., SINR, CQI, RSRQ, CLI, etc.).

A WTRU may perform one or more measurements on one or more different frequency resources as the received RS. In examples, a WTRU may be configured, determined, and/or indicated (e.g., via RRC, MAC-CE, DCI) to measure one or more reference signals in one or more frequency domain resources, where the reference signal is received in a different and/or another frequency domain resources. In examples, the WTRU may receive the reference signal in a first type of frequency domain resources (e.g., UL subbands, RBs, BWPs, etc.), where the WTRU measures the reference signal in a second type of frequency resources (e.g., DL subbands, RBs, BWPs, etc.), in a third type of frequency resources (e.g., Flexible subbands, RBs, BWPs, etc.), in a fourth type of frequency resources (e.g., guardbands), and/or the like.

The WTRU may receive configuration (e.g., via RRC, MAC-CE, DCI) on one or more CSI-RS resource sets, including CSI resource settings to be NZP-CSI-RS resources, ZP-CSI-RS resources, CSI-IM resources, and/or the like. One or more of the following may apply: NZP-CSI-RS resources; ZP-CSI-RS resources; and/or CSI-IM resources. If the CSI resource setting is set to NZP-CSI-RS resources, for example, the WTRU may use the one or more measured parameters based on the configured reference signal for channel and/or interference measurements, calculations, and/or estimations (e.g., RSRP, SINR, RSRQ, CLI, etc.). For example, a first WTRU (e.g., victim UE) may receive one or more SRS signals transmitted via at least a second WTRU (e.g., aggressor UE) in UL subbands within SBFD configuration. The first WTRU may be configured to measure the (e.g., effect of) received SRS signal in the DL subband, flexible subband, and/or guardbands, via NZP-CSI-RS resources, to determine the interfering impact of such transmission in DL subband, flexible subband, and/or guardbands (e.g., for CLI measurement). For example, the first WTRU may be configured to measure reference signal's received power (e.g., SRS-RSRP) in the DL subband, flexible subband, and/or guardbands. If the CSI resource setting is set to ZP-CSI-RS resources, for example, the WTRU may use the resources to measure parameters based on received signals' strength for channel and/or interference measurements, calculations, and/or estimations (e.g., RSSI, CLI, etc.). For example, a first WTRU (e.g., victim WTRU) may receive one or more SRS signals transmitted via at least a second WTRU (e.g., aggressor WTRU) in UL subbands within SBFD configuration. The first WTRU may be configured to measure the (e.g., effect of) received SRS signal in the DL subband, flexible subband, and/or guardbands, via ZP-CSI-RS resources and/or muted resources, to determine the interfering impact of such transmission in DL subband, flexible subband, and/or guardbands (e.g., for CLI measurement). For example, the first WTRU may be configured to measure reference signal's strength (e.g., CLI-RSSI, SRS-CLI-RSSI) in the DL subband, flexible subband, and/or guardbands. If the CSI resource setting is set to CSI-IM resources, the WTRU may use the one or more measured parameters based on the configured reference signals and/or resources for interference measurements, calculations, and/or estimations (e.g., interference, CLI, etc.). In examples, a first WTRU (e.g., victim WTRU) may receive one or more SRS signals transmitted via at least a second WTRU (e.g., aggressor WTRU) in UL subbands within SBFD configuration. The first WTRU may be configured to measure the interference received in the DL subband, flexible subband, and/or guardbands, via CSI-IM resources (e.g., for CLI measurement). For example, the first WTRU may be configured to measure reference signal's strength (e.g., CLI-RSSI) in the DL subband, flexible subband, and/or guardbands.

A WTRU may be configured in association with two-step settings indication (e.g., timing advance offset, repetition, muted/CSI-ZP resources/CSI-NZP resources/CSI-IM, power backoff/adjustments, etc.).

Embodiments are described herein for performing aperiodic measurement, configuration, and/or triggering. A first WTRU (e.g., potential victim WTRU) may receive one or more configurations (e.g., via RRC, MAC-CE, DCI) to measure one or more parameters (e.g., RSRP, CLI, etc.) based on one or more reference signals that are transmitted from at least a second WTRU (e.g., potential aggressor WTRU). For example, the first WTRU may receive configuration information associated with one or more SRS resources. The configuration may include resources to measure the configured reference signals, where the measurements may be configured to be aperiodic.

In examples, the first WTRU may receive one or more configurations to perform aperiodic measurements based on (e.g., associated with) one or more aperiodic reference signals (e.g., SRS) received from the second WTRU. In examples, the configurations may include the resource type indicating the aperiodic configuration of the resources, one or more lists of aperiodic trigger states, resource mapping to indicate the time and/or frequency resources for monitoring and/or measuring the configured reference signals, and/or the like. For example, the first WTRU may receive a trigger to receive an SRS transmission in an SRS resource of one or more SRS resources and/or may measure CLI. The SRS resources may be associated with a time.

In examples, the first WTRU may receive one or more triggering signaling (e.g., via MAC-CE, DCI) to trigger aperiodic measuring of one or more reference signals' resource sets based on the configured time and/or frequency resources for measurement, where the reference signals may be transmitted from at least a second WTRU. For example, the first WTRU may receive a trigger to receive an SRS transmission in an SRS resource of one or more SRS resources and/or may measure CLI. The SRS resources may be associated with a time.

A WTRU may be configured in association with two-step settings indications for aperiodic measurements. The WTRU may receive a first parameter and/or setting via a configuration (e.g., via RRC, MAC-CE, DCI) for an aperiodic measurement, and the WTRU may receive a second parameter and/or setting via an indication (e.g., via MAC-CE, DCI), where the WTRU may use the second parameter and/or setting to replace, substitute, adjust, change, and/or modify the first parameter and/or setting. For example, one or more of the following may apply: starting time adjustment; repetition number; power backoff; and/or the like. With respect to starting time adjustment, for example, the WTRU may receive a starting time configuration and an indicated timing advance offset for the reception and/or transmission of a configured and/or indicated DL/UL signal or channel, where the WTRU may use the second indicated timing advance offset to adjust the starting time and/or to start in advance to the configured starting time for the reception and/or transmission of the configured and/or indicated DL/UL signal and/or channel. With respect to repetition number, for example, the WTRU may be configured with a repetition number of the transmission and/or reception of a signal and/or channel, where the WTRU may use the received second indication to adjust of substitute the configured repetition number accordingly. With respect to power backoff, for example, the WTRU may be configured with a power adjustment and/or power back-off value, where the WTRU may use the received second indication for correcting, adjusting, and/or modifying the power backoff value accordingly.

A WTRU may be configured (e.g., via RRC, MAC-CE, DCI) with one or more parameters (e.g., for an aperiodic measurement) where the configuration may be divided in one or more different levels of properties. In examples, the (e.g., overall) CSI-RS configuration may be divided to one or more (e.g., three) different levels of properties, namely: CSI-ResourceConfig, CSI-RS-ResourceSet, and/or CSI-RS-Resource, where high level, behavioral, and/or resource level properties may be included (e.g., defined), respectively.

In examples, a WTRU may be configured (e.g., via RRC, MAC-CE, DCI) with a first configured parameter as part of a first level of properties, a second level of properties, a third level of properties, and/or the like, where a second received indication (e.g., via MAC-CE, DCI) may result in adjusting, substituting, and/or modifying the configured parameter in the respective level. In examples, adjusting, substituting, and/or modifying a configured parameter in a level of properties may result in adjusting, substituting, and/or modifying the configured parameter in the one or more lower levels of properties. For example, one or more of the following may apply. In examples, the WTRU may be configured with a first parameter (e.g., starting time) as part of CSI-ResourceConfig. Therefore, for example, the second received indication (e.g., timing advance offset) may be applied to each corresponding and/or associated CSI-RS resource sets and/or CSI-RS resources. In examples, the WTRU may be configured with a first parameter (e.g., starting time) as part of CSI-RS-ResourceSet. Therefore, for example, the second received indication (e.g., timing advance offset) may be applied to each CSI-RS resource configured in that CSI-RS resource set. In examples, the WTRU may be configured with a first parameter (e.g., starting time) as part of CSI-Resource configuration. Therefore, for example, the second received indication (e.g., timing advance offset) may be applied (e.g., only) to the specific configured SRS resource of the SRS resource set. In examples, the first parameter may be configured in one or more levels of CSI-RS configuration. For example, the WTRU may be configured with the value for the first parameter in both CSI-RS resource set and CSI-RS resource. Therefore, the second received indication (e.g., timing advance offset, e.g., via MAC-CE or DCI may point to a specific combination of the values for the first parameter configured in CSI-RS resource set and CSI-RS resource.

With respect to MAC-CE indication of the second indication, for example, a WTRU may receive a first parameter and/or setting (e.g., starting time, power backoff, repetition, etc.) via a configuration (e.g., via RRC, MAC-CE, DCI) for an aperiodic (CSI-RS) measurement, and the WTRU may receive a second parameter and/or setting via an indication (e.g., via MAC-CE), indicating the replacing and/or substituting values for adjusting, changing, and/or modifying the first parameter and/or setting. The second indication (e.g., MAC-CE) may be received prior, after, and/or on the same slot where an aperiodic CSI measurement is triggered (e.g., via DCI). In examples, the second indication (e.g., via MAC-CE) may be valid indefinitely until updated. In examples, the second indication (e.g., via MAC-CE) may be configured with a time validity window with reference to the reception of the triggering command (e.g., DCI in PDCCH), by which the WTRU may consider the second indicated parameter (e.g., only) for the one or more (CSI-RS) measurements that are triggered within that window.

With respect to DCI indication of the second indication, for example, a WTRU may receive a first parameter and/or setting (e.g., starting time, power backoff, repetition, etc.) via a configuration (e.g., via RRC, MAC-CE, DCI) for an aperiodic (CSI-RS) measurement, where the WTRU may use the configured parameter and/or setting. The WTRU may receive an indication (e.g., DCI) on a second parameter and/or setting (e.g., after using the first configured parameter and/or setting) to use the second parameter and/or modify and/or adjust the first configured parameter for one or more of: a specific transmission (e.g., DCI based); a time period (e.g., timer based); one or more (e.g., a number of) transmissions (e.g., DCI or MAC-CE based); and/or until an indication to switch back (or again) may be received (e.g., based on activation and/or deactivation that may be received in a DCI and/or MAC-CE).

With respect to dynamic indication of timing advance offset (TAO) values, for example, a first WTRU (e.g., potential victim UE) may receive one or more indications (e.g., dynamic indication, e.g., via MAC-CE, DCI) including one or more timing offset values for receiving one or more reference signals (e.g., aperiodic) transmitted from at least a second WTRU (e.g., potential aggressor WTRU). The first WTRU may determine the time resources to monitor, receive, and/or measure the configured (aperiodic) reference signal(s), for example, based on a two-step indication method. That is, the first WTRU may use the one or more (e.g., dynamically) indicated timing offset values in addition to the configured time resources to determine the time resources to monitor, receive, and/or measure the configured (aperiodic) reference signal(s) (e.g., that may be associated to an aperiodic SRS transmission from a second WTRU). For example, the first WTRU may receive and/or determine a timing offset associated with the SRS transmission. For example, the first WTRU may receive one or more different timing advance offset values that are associated with the different second WTRUs that are configured to transmit the configured reference signals (e.g., SRS). In examples, the first WTRU may adjust the time resources to monitor, receive, and/or measure the configured (aperiodic) reference signal(s) by starting in advance based on the indicated timing offset values, with regards to the configured time resources. The timing advance offset, as described herein, may be a second timing advance for the purpose of this type of aperiodic RS transmission, separated from a first timing advance that is used for other UL transmissions at a second WTRU (e.g., PUCCH, PUSCH, SRS transmission at an aggressor WTRU). For example, the timing offset may be a TA for reception of the SRS transmission from the second WTRU that is separate from a TA that the first WTRU uses for transmission of an uplink transmission. The first WTRU may determine the second timing offset based on when the first WTRU receives the SRS transmission in the time window and/or the time of the SRS resource.

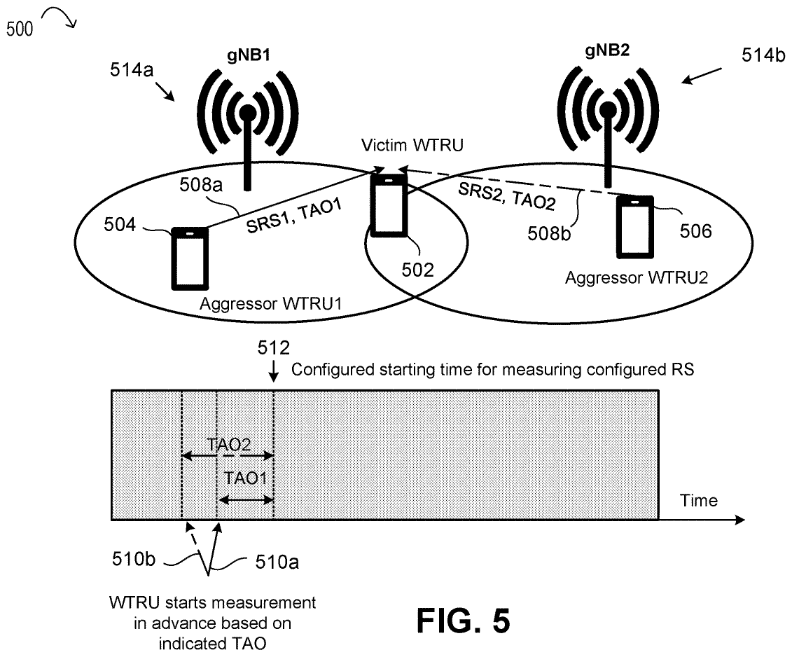

FIG. 5 depicts an example for two-step timing advance configuration 500. In FIG. 5, the first (e.g., victim) WTRU 502 may be configured (e.g., via RRC, MAC-CE, DCI) with a starting time to receive and/or measure a reference signal (e.g., SRS) from a second WTRU 504, 506. The first (e.g., victim) WTRU 502 may receive indication (e.g., via MAC-CE, DCI) on the reference signal that may be used by the second WTRU 504, 506 (e.g., SRS1 and/or SRS2 used by aggressor WTRU1 504 and/or aggressor WTRU2 506, respectively). The first (e.g., victim) WTRU 502 may receive indication (e.g., via MAC-CE, DCI) on the timing advance offset (TAO) that is associated with the second WTRU 504, 506 (e.g., TAO1 and TAO2 for aggressor WTRU1 504 and aggressor WTRU2 506, respectively).

At 508a, for example, Aggressor WTRU 1 504 may send SRS1 to the first (e.g., victim) WTRU 502. At 508b, for example, Aggressor WTRU2 506 may send SRS2 to the first (e.g., victim) WTRU 502.

The first WTRU 502 may determine to start receiving and/or measuring the indicated reference signal (e.g., SRS1 and/or SRS2) in advance based on the indicated TAO (e.g., TAO1 and/or TAO2) with regards to the configured starting time for receiving and/or measuring the RS (e.g., SRS). For example, the first (e.g., victim) WTRU 502 may receive and/or determine a timing offset associated with the SRS transmission. Determining the timing offset may be based on reception of the timing offset associated with the SRS transmission. The timing offset may be received via DCI and/or MAC CE. The first (e.g., victim) WTRU 502 may receive and/or determine to start one or more measurements based on one or more TAOs. For example, at 510a, the first (e.g., victim) WTRU 502 may start one or more measurements in advance based on SRS1 (e.g., sent at 508a from Aggressor WTRU1 504). For example, at 510b, the first (e.g., victim) WTRU 502 may start one or more measurements in advance based on SRS2 (e.g., sent at 508b from Aggressor WTRU2 506). At 512, the first (e.g., victim) WTRU 502 may be configured with a starting time for measuring configured RS (e.g., SRS).

In examples, a first WTRU (e.g., a potential victim WTRU) may determine the time (window) to monitor, receive, and/or measure a configured and/or indicated RS (e.g., SRS) transmitted from at least a second WTRU (e.g., aggressor WTRU 504, 506), where the timing advance offset may have zero or non-zero values. For example, the first WTRU may determine a time and/or a time window to receive the SRS transmission based on the time associated with the SRS resource and/or the timing offset. The first (e.g., victim) WTRU 502 may receive the SRS transmission based on the time and/or the time window. The SRS transmission may be transmitted by a second WTRU (e.g., aggressor WTRU1 504 and/or aggressor WTRU2 506).

The first (e.g., victim) WTRU 502 may perform one or more measurements on the SRS transmission. Performing the one or more measurements may include performing one or more aperiodic measurements, for example, based on one or more aperiodic SRSs. The first (e.g., victim) WTRU 502 may send a message to a network node. For example, the first (e.g., victim) WTRU 502 may send the message to a network node associated with gNB1 514a. For example, the first (e.g., victim) WTRU 502 may send the message to a network node associated with gNB1 514b. The message may include (e.g., an indication of) the one or more measurements. The one or more measurements may include WTRU-to-WTRU CLI, for example, based on the received transmission. The WTRU-to-WTRU CLI may include SRS-RSRP and/or CLI-RSSI in UL SB and/or DL SB.

In examples, the first WTRU may receive one or more indications on one or more non-zero TAOs, where the (e.g., exact) time values may be indicated for the TAOs. In examples, the first WTRU may receive one or more delta offset values (e.g., +/−n) for the timing advance offset indication. As such, for example, the first WTRU may determine the timing advance offset by adding the indicated delta offset values with the timing advance that may be configured for the first WTRU (e.g., configured via timing advance commands (TAC) for the configured, triggered, and/or indicated UL transmissions form the first WTRI, e.g., PUSCH, PUCCH, SRS). For example, the timing offset may be a delta offset value. The delta offset value may indicate one or more (e.g., a number of) TA instances with respect to the UL transmission TA value of the first WTRU.

In examples, the first WTRU may receive one or more indications on one or more zero TAOs. As such, for example, the first WTRU may determine the indicated TAO to be zero, where the first WTRU may not use one or more (e.g., any) timing advance for monitoring, receiving, and/or measuring the configured and/or indicated reference signals. In examples, the first WTRU may not receive one or more (e.g., any) configuration and/or indication on the TAO, where the first WTRU may determine to consider the TAO to be zero.

With respect to dynamic indication of repetition values, for example, a first WTRU (e.g., potential victim WTRU) may receive one or more indications (e.g., dynamic indication, e.g., via MAC-CE, DCI) including repetition values for receiving one or more reference signals (e.g., aperiodic SRS) transmitted from at least a second WTRU (e.g., potential aggressor WTRU). For example, the first (e.g., victim) WTRU 502 may receive SRS repetition information. The first (e.g., victim) WTRU 502 may measure repeated SRS transmission, for example, based on the SRS repetition information.

The first WTRU may use the second indication on the one or more (e.g., number of) repetitions for receiving and/or measuring the configured and/or indicated parameters, for example, based on the configured and/or indicated reference signal. That is, the first WTRU may use the (e.g., dynamically) indicated repetition values instead of the configured repetitions to determine one or more (e.g., the number of) repetitions to monitor, receive, and/or measure the configured (aperiodic) reference signal(s) (e.g., that may be associated to an aperiodic SRS transmission from a second WTRU).

With respect to dynamic indication of resources (e.g., NZP CSI-RS, ZP CSI-RS, CSI-IM), for example, a first WTRU (e.g., potential victim WTRU) may be configured (e.g., via RRC, MAC-CE, DCI) with one or more candidate time and/or frequency resources (e.g., NZP CSI-RS, ZP CSI-RS, CSI-IM, muted resources, and so forth) for (e.g., aperiodic) CSI measurement (e.g., SRS-RSRP based on aperiodic SRS transmitted from at least a second WTRU (e.g., potential aggressor WTRU)), where the first WTRU may receive a second indication (e.g., via MAC-CE, DCI) to select the one or more resources to be used from the first list.

As such, for example, the first WTRU may use the second indication to select the one or more resources from the first configured list for receiving and/or measuring the configured and/or indicated parameters based on the configured and/or indicated reference signal. That is, the first WTRU may use the (e.g., dynamically) indicated resources to monitor, receive, and/or measure the configured (e.g., aperiodic) reference signal(s) (e.g., that may be associated to an aperiodic SRS transmission from a second WTRU).

With respect to measurement and/or reporting, a first WTRU (e.g., victim WTRU) may perform channel and/or interference measurements, for example, based on one or more configured and/or parameters in configured and/or indicated resources. In examples, the first WTRU may receive one or more reference signals (e.g., SRS) in a first type of frequency resources (e.g., UL SB, e.g., in SBFD configuration), where the first WTRU may measure received power, for example, based on the reference signal (e.g., SRS-RSRP) in the same frequency resources. In examples, the first WTRU may receive one or more reference signals (e.g., SRS) in a first type of frequency resources (e.g., UL SB, e.g., in SBFD configuration), where the first WTRU measures received power based on the reference signal (e.g., SRS-RSRP) and/or the received signal strength (e.g., CLI-RSSI and/or SRS-CLI-RSSI) in a different set of frequency resources and/or with a second type of frequency resources (e.g., DL SB, e.g., in SBFD configuration). The first WTRU may report the one or more measured parameters (e.g., to a gNB), for example, based on the configured reporting resources and/or periodicity.

The first WTRU may determine and/or estimate one or more parameters, for example, based on the received reference signals. For example, the first WTRU may determine the timing advance offset corresponding to a second WTRU based on the received SRS from the second WTRU. The first WTRU may report the estimated timing advance offset for the corresponding second WTRU (e.g., to a gNB), for example, based on the configured reporting resources and/or periodicity. For example, the first WTRU may send a report to a network node. The report may include the measured CLI value(s) and/or the second timing offset.

Embodiments are described herein for handling aperiodic SRS transmission at a WTRU. A WTRU (e.g., first WTRU) may perform one or more of the following. A first WTRU (e.g., potential aggressor WTRU) may receive configuration (e.g., including time and/or frequency resources in its serving cell) for one or more aperiodic SRS transmissions (e.g., in UL SB in SBFD configuration). For example, the first WTRU may receive configuration information associated with one or more SRS transmissions. For example, a first WTRU may receive configuration for one or more aperiodic SRS transmissions for CLI measurement at a second WTRU (e.g., potential victim WTRU).

With respect to timing advance, for example, the first WTRU may receive an indication indicating what cell (e.g., and/or whether to use its serving cell and/or a different cell) to use as the reference for timing and/or timing advance for an SRS transmission using resources of its serving cell. For example, the first WTRU may receive an indication indicating a serving cell of a second WTRU to be used to determine a timing and/or a timing advance of an SRS transmission. The indication may be based on radio resource control (RRC) indication of a set of resources (e.g., for the serving cell and/or another cell). For example, the first WTRU may receive the indication via a RRC indication of a set of resources.

The WTRU may receive configuration information associated with one or more SRS transmissions. The first WTRU may receive the indication via DCI and/or MAC CE. For example, the first WTRU may receive indication via DCI/MAC-CE for selection from the set.

The first WTRU may determine a time for the SRS transmission based on the indication. For example, the first WTRU may determine a time to be used for the SRS transmission based on the same serving cell or a different/non-serving cell. Based on the same serving cell (e.g., in the case the victim WTRU and the aggressor WTRU are in the same cell), the first WTRU may determine the time to transmit the SRS based on its serving cell's DL timing (e.g., plus timing advance information and/or commands (received from the gNB)). For example, upon a determination that the serving cell of the second WTRU is the same serving cell of the first WTRU, the first WTRU may determine the time to transmit the SRS transmission based on a DL timing of the serving cell. The timing advance may be a first type of timing advance that the first WTRU uses for transmission of UL signals and/or channels (e.g., physical uplink control channel (PUCCH), physical uplink shared channel (PUSCH), SRS, etc.), and/or the timing advance may be a second type of timing advance that the first WTRU uses for the transmission of SRS to be measured by the second WTRU. The first WTRU may receive the configuration on the timing advance (e.g., via RRC, MAC-CE, and/or DCI). Based on a different/non-serving cells (e.g., in case the victim WTRU and aggressor WTRU are not in the same cell), the first WTRU may determine to transmit the SRS based on the indicated cell's DL reference timing (e.g., plus timing advance information (received from gNB). For example, upon a determination that the serving cell of the second WTRU is a neighboring cell of the first WTRU, the first WTRU may determine the time to transmit the SRS transmission based on a DL timing of the neighboring cell. Upon a determination that the serving cell of the second WTRU is a neighboring cell of the first WTRU, the first WTRU may measure one or more DL RSs from the neighboring cell to determine the DL timing.

The timing advance may be a first type of timing advance that the first WTRU uses for transmission of UL signals and/or UL channels (e.g., PUCCH, PUSCH, SRS, etc.), and/or the timing advance may be a second type of timing advance that the first WTRU uses for the transmission of SRS to be measured by the second WTRU. For example, the first WTRU may send the SRS transmission, based on the second timing advance, to be measured by a second WTRU. The timing advance for the cases with different/non-serving cells may be similar or different from the timing advance that the first WTRU may use for transmission in the same serving cell. The WTRU may receive the configuration on the timing advance (e.g., via RRC, MAC-CE, and/or DCI). The first WTRU may measure one or more configured and/or indicated DL RS (e.g., SSB, CSI-RS, etc.) from the indicated cell to determine the DL timing, e.g., for the purpose of this type of aperiodic SRS transmission. The first WTRU may transmit SRS (e.g., using resources of its serving cell) using the determined DL timing and/or timing advance. For example, the first WTRU may send the SRS transmission based on the determined time to transmit the SRS transmission. For example, the first WTRU may determine the time to transmit the SRS transmission based on the timing advance that the first WTRU uses for UL transmissions in the serving cell of the first WTRU.

The first WTRU may be configured with first SRS resource(s) within the UL SB and/or second SRS resource(s) outside of the UL SB (e.g., inside a DL SB) (e.g., of an SBFD slot or other time unit). The first WTRU may determine a power adjustment to apply and/or whether to apply a power adjustment to the SRS transmission, for example, based on whether the SRS transmission resource(s) is/are within an UL SB and/or a DL SB (e.g., first SRS resource or second SRS resources, respectively), and in case the SRS transmission resource is within an UL SB, how close it is to a boundary of the UL SB. For example, the first WTRU may determine a power adjustment to apply to the SRS transmission based on whether the SRS transmission resources are within an UL SB or a DL SB, and/or based on one or more power control (PC) related parameters. In examples, the first WTRU may receive configuration of one or more power adjustments (e.g., backoff) values. For example, the first WTRU may receive one or more power adjustment values. The power adjustment values may be included in the one or more adjustment values. For example, when the SRS transmission resource(s) may be in the first SRS resources (e.g., UL SB), the first WTRU may perform transmission of the SRS without applying the one or more power adjustment values. The first WTRU may send the SRS transmission without applying the one or more adjustment values; the SRS transmission resources may be included within an UL SB. For example, when the SRS transmission resource(s) (e.g., one or more of the SRS transmission resources) is in the second SRS resources (e.g., DL SB), the first WTRU may transmit the SRS applying a power adjustment to the transmission power where the power adjustment (e.g., from the configured power adjustments) is determined based on one or more of: a frequency (e.g., resource block (RB)) distance between a boundary of the UL SB and a reference RB of the SRS resource; and/or a minimum frequency (e.g., RB) distance between a boundary of the UL SB and an RB of the SRS resource. For example, the first WTRU may send the SRS transmission based on one or more of: a frequency distance between a boundary of the UL SB and a reference RB of a SRS resource or a minimum frequency distance between a boundary of the UL SB and a RB of the SRS resource; the SRS transmission resources may be included within a DL SB.

A WTRU may be configured and/or indicated to transmit one or more SRSs, where an SRS resource of the one or more SRSs may be configured for a (e.g., particular) purpose of one or more of: beam management, channel acquisition (e.g., based on channel reciprocity), link adaptation, antenna switching, and/or the like. The (e.g., particular) purpose may be interpreted to be for a communication link between the WTRU and a gNB (e.g., its serving gNB, cell, TRP, etc.), which may be denoted by a first SRS type. The first SRS type may be a non-limiting example of a type of SRS that may be used for and/or to support a communication link between the WTRU and its serving cell and/or TRP and/or gNB. The WTRU may (e.g., be configured) to apply a first timing advance (TA) to the transmission associated with the first SRS type, where the first TA may be used for one or more (e.g., other) uplink transmission cases including PUSCH, PUCCH, PRACH, and/or the like. The first TA may be obtained from a RACH procedure, e.g., based on contention-based RACH (e.g., via initial access mechanism) and/or contention-free RACH (e.g., via a PDCCH order command signaled by a DCI). The first TA may be updated via a TA command (TAC) received from higher-layer signaling (e.g., MAC-CE). In examples, the WTRU may be configured and/or indicated to transmit second one or more SRS resources at least for CLI measurement purpose at a receiver side, which may be denoted by a second SRS type. The second SRS type may be a non-limiting example of a type of SRS that may be used for and/or to support at least the one or more CLI measurements at a receiver side (e.g., other WTRU(s), gNB(s), other communication device and/or node(s) in the network). One or more (e.g., any) other type of transmission may be substituted for the transmission, for example, ] based on the second SRS type. The one or more CLI measurements at the receiver side (e.g., a second WTRU) may include one or more of: an energy-level and/or power-level measurement (e.g., CLI-RSSI) on a configured and/or indicated DL resource (e.g., a form of zero-power resource, a configured CLI-measurement resource, and/or the like); a sequence-based and/or correlation-based RS power measurement (e.g., SRS-RSRP) on a configured and/or indicated RS sequence and/or resource (e.g., SRS resource which may be transmitted from the WTRU causing the CLI to the second WTRU); an SINR and/or CQI type of channel quality metric derivation to be reported; and/or the like.

The WTRU, scheduled and/or indicated to transmit an SRS (e.g., based on an SRS resource associated with the second SRS type), may receive a configuration and/or an indication that the SRS is associated with a second TA (e.g., instead of and/or separated from the first TA). The WTRU may transmit the SRS using resource(s) of its serving cell but by applying the second TA instead of the first TA that is being used for other UL transmissions (e.g., PUCCH, PUSCH, the first SRS type, PRACH, etc.) to the serving cell. The WTRU may determine the second TA, for example, based on one or more of the following behaviors: determination of DL reference timing and/or determination of UL transmission timing associated with a TA.

With respect to determination on DL reference timing, for example, the second TA may be determined as a relative timing offset from a DL reference timing, where the DL reference timing may be based on a (e.g., physical) cell-ID (e.g., PCI). In examples, compared to the first TA being determined based on the WTRU's serving-cell PCI X, the second TA may be determined, for example, based on an indicated and/or configured PCI Y (e.g., other than the WTRU's serving-cell PCI X) which may be configured by RRC and/or MAC-CE and/or indicated by a dynamic signaling, e.g., DCI. The WTRU may determine the DL reference timing for the second TA based on measuring one or more signals (e.g., SSB(s), CSI-RS(s), etc.) transmitted from a second cell associated with the indicated or configured PCI Y.

With respect to determination on UL transmission timing associated with a TA, for example, based on a DL reference timing determined based on the indicated and/or configured PCI, the WTRU may determine a UL transmission timing (e.g., at least for transmission of the second SRS type) based on the second TA in response to receiving a second TA command signaling that may be separated and/or independent from a TAC message for determination of the first TA. In examples, the WTRU may determine the first TA (e.g., to be applied for at least the first SRS type) based on a DL reception timing D1 (e.g., as a starting time of a DL slot or symbol) transmitted by the WTRU's serving-cell (e.g., associated with PCI X), and/or based on a first time-domain offset O1 which may be determined by a single TAC (e.g., absolute TA command) and/or by one or more (e.g., multiple) TAC messages received during a period of time (e.g., accumulated TA process). In response to the determining, for example, the WTRU may determine the first TA pointing to a time instance of D1+O1, where O1 may be a positive value, a negative value, or zero. At the time instance of D1+O1, for example, the WTRU may start to transmit a UL signal/channel, based on the determination of D1 which may be based on the UL signal/channel scheduled and/or configured to transmit. The WTRU may determine the second TA (e.g., to be applied for at least the second SRS type) based on a DL reception timing D2 (e.g., as a starting time of a DL slot and/or symbol) transmitted by a cell and/or gNB and/or TRP associated with PCI Y, and/or based on a second time-domain offset O2 which may be determined by the second TA command signaling that may be separated and/or independent from the single and/or one or more (e.g., multiple) TAC message(s) for determining the first TA. Based on the separated information in the second TA command signaling, for example, the WTRU may determine the second TA pointing to a time instance of D2+O2, where O2 may be a positive value, a negative value, or zero. At the time instance of D2+O2, the WTRU may start to transmit a UL signal (e.g., at least the second SRS type), for example, based on the determination of D2 which may be based on the UL signal indicated and/or configured to transmit.

Using the second TA, for the WTRU (e.g., as an aggressor WTRU), applicable at least for the second SRS type (e.g., for CLI measurement purpose, e.g., at a second WTRU being a victim WTRU) may include one or more of the following. Determination of the second TA that may be based on the DL reference timing of other cell (e.g., associated with PCI Y which may be different from the WTRU's serving cell with PCI X), where the other cell (e.g., with PCI Y) may be a serving cell for the second WTRU (e.g., as a victim WTRU). The WTRU (e.g., as aggressor) may transmit the second SRS type in order for the second WTRU (e.g., as victim WTRU) to receive it within a DL reception window determined, for example, based on the second WTRU's serving cell with PCI Y. At the second WTRU side, for example, the WTRU (e.g., as aggressor WTRU) may (e.g., selectively) apply the second TA when transmitting at least the second SRS type, while the WTRU may (e.g., selectively) apply the first TA when transmitting one or more other UL signals and/or channels to its serving cell (e.g., with PCI X). This may reduce the second WTRU's CLI measurement complexity and/or may improve the CLI measurement accuracy, as well as resource utilization efficiency, for example, based on potentially reducing one or more (e.g., the number of) repeated SRS symbols (e.g., SRS symbols necessary) (e.g., or no repetition needed) of the second SRS type, due to the alignment with the DL reception window at the second WTRU (e.g., as victim WTRU), based on applying the second TA at the WTRU (e.g., as aggressor WTRU).

In examples, in case when the WTRU (e.g., as aggressor WTRU) and the second WTRU (e.g., as victim WTRU) are in the same cell (e.g., with the same PCI Z), the WTRU (e.g., as aggressor WTRU) may determine the time to transmit the SRS (e.g., of the second SRS type) based on serving cell's DL timing associated with the same PCI Z, where the second TA command signaling may (e.g., still) be separately given to the WTRU, which may make the second TA being different from the first TA, although both may be derived based on the same DL reference timing with the same PCI Z.

With respect to information exchange between one or more gNBs, (e.g., cell, TRP, node), for example, information contents for enabling such inter-WTRU CLI measurements may be exchanged (e.g., via backhaul link signaling, e.g., X2, Xn interface type of signaling), where the information contents may include one or more of following. Information contents may include WTRU ID(s) as a (e.g., potential) aggressor and/or victim (e.g., in terms of CLI, full-duplex mode, SBFD mode/type, etc.), where a (e.g., each) WTRU ID of the WTRU ID(s) may be associated with its serving cell and/or gNB and/or TRP identifier, e.g., PCI and/or a TRP ID, etc. One or more (e.g., each) WTRU ID of the WTRU ID(s) may be associated with SBFD-related configuration such as time and/or frequency location of one or more of: UL subband, DL subband, Flexible subband, and/or guard band. In examples, a transmission direction (e.g., either DL or UL) on the Flexible subband may be determined via other type of signaling, e.g., a group-common DCI, a MAC-CE signaling, and/or a DCI scheduling an (e.g., actual) DL and/or UL signal and/or channel on the Flexible subband, etc. Information contents may include a transmission and/or reception resource (e.g., SRS, and/or a measurement resource) associated with one or more of the WTRU ID(s). Information contents may include a timing advance value (e.g., or a timing offset value) associated with a WTRU ID, where the timing advance value (e.g., and/or the timing offset value) may represent how the current timing offset in terms of UL transmission timing compared with a DL reference timing associated with a PCI. The timing advance value (e.g., and/or timing offset value) may be delivered from a victim WTRU's serving cell and/or gNB and/or TRP to an aggressor WTRU's serving cell and/or gNB and/or TRP, and/or may be used for the aggressor WTRU's serving cell and/or gNB and/or TRP to signal an initial value related to the second TA (e.g., via the second TA command signaling) to the aggressor WTRU, e.g., if the victim WTRU and the aggressor WTRU are located in proximity. Information contents may include a pair of WTRU IDs that are identified as a potential aggressor-victim relation to each other. Information contents may include spatial-domain related parameter(s) associated with one or more WTRU ID. Information contents may include power-control related parameter(s) associated with one or more WTRU ID.

With respect to Tx power determination aspect(s), the WTRU (e.g., as aggressor WTRU) may receive configuration parameter(s) and/or an indication that indicates one or more power control (PC) related parameters associated with an SRS transmission based on the second SRS type (e.g., at least for CLI measurement purpose), where the PC related parameter(s) may include one or more of the following. PC related parameter(s) may include open-loop PC parameters such as PO, alpha, pathloss determination parameter. PC related parameter(s) may include closed-loop PC parameters such as a closed-loop index that may be (e.g., dynamically) indicated by a DCI. PC related parameter(s) may include another PC offset parameter at least to be used for a type of advanced full duplex operation, e.g., SBFD, or subband partially/full-overlapping FD, etc.

The WTRU may determine a transmission power value for transmission of a UL signal (e.g., of the second SRS type), based on one or more of the PC related parameters, for example, on condition that the UL signal is transmitted outside of a UL subband, e.g., for the SBFD operation. The WTRU may receive a configuration and/or indication on the location of the UL subband where the WTRU may be allowed for transmission of a UL transmission. The WTRU may be configured to transmit (e.g., exceptionally) the UL signal (e.g., of the second SRS type for CLI measurement purpose) outside the UL subband, for example, based on applying a UL power adjustment by the determined transmission power value in transmission of the UL signal.

In examples, the UL power adjustment (e.g., backoff) may reduce the Tx power value compared with a second Tx power value that is to be applied for transmission of other UL signal/channel, e.g., PUSCH, PUCCH, the first SRS type, etc. The UL signal (e.g., of the second SRS type) with the UL power adjustment (e.g., with a reduced power) may be transmitted outside the UL subband (e.g., inside a DL subband and/or guard band), which may be measured by the second WTRU (e.g., as victim WTRU) as a mimicked CLI leakage power that may be similarly measured when the WTRU (e.g., as aggressor WTRU) (e.g., actually) transmits a UL signal inside the UL subband with not-adjusted (e.g., not-reduced) Tx power. Allowing such a direct UL signal transmission outside the UL subband may allow the second WTRU (e.g., as victim WTRU) to differentiate who transmitted the UL signal (e.g., a WTRU-ID, and/or a parameter(s) of the transmitted SRS sequence) when one or more (e.g., multiple) aggressor WTRUS transmitted such SRSs of the second SRS type.

In examples, the WTRU may determine to apply one or more of the PC related parameters, for example, based on a frequency distance between the UL signal (e.g., SRS of the second SRS type) and at least one location-related parameter(s) of a subband (e.g., UL subband, DL subband, Flexible subband, and/or guard band), e.g., to be used for a type of advanced full duplex operation/mode, e.g., SBFD, and/or subband partially/full-overlapping FD, etc. In examples, based on a frequency (e.g., RB) distance between a boundary of the UL SB and a (e.g., reference) RB of the UL signal (e.g., SRS resource which may be associated with the second SRS type), the WTRU may determine to apply one or more of the PC related parameters to transmission of the UL signal. In examples, based on the minimum frequency (e.g., RB) distance between a boundary of the UL SB and an RB of the UL signal (e.g., SRS resource which may be associated with the second SRS type), the WTRU may determine to apply one or more of the PC related parameters to transmission of the UL signal.

Embodiments described herein relate to hierarchical SRS configuration and/or CLI measurement that may be implemented over one or more shared resources. A first WTRU may receive configuration information that includes an indication that the first WTRU is to measure one or more CLI measurements in time and/or frequency resources associated with one or more (e.g., a plurality) of SRS transmissions. For example, the first WTRU (e.g., victim WTRU) may receive configuration to measure and/or report CLI (e.g., SRS-CLI-RSSI). For example, the first WTRU may receive configuration to measure and/or report CLI in a DL SB. The CLI measurements may include SRS-CLI-RSRP measurements and/or SRS-CLI-RSSI measurements. The configuration may include the time and/or frequency resources where one or more SRS transmissions (e.g., from one or more second (aggressor) WTRUs) using one or more sequences may be received and/or measured by the first WTRU. The one or more SRS transmissions using one or more sequences may be received and/or measured by the first WTRU at the same (e.g., and/or overlapping) time and/or frequency resources (e.g., group-SRS-transmission). For example, the one or more (e.g., multiple) different SRS sequences may be transmitted to the first WTRU by one or more other WTRUS.

The CLI (e.g., SRS-CLI-RSSI) measurement and/or reporting may be periodic, semi-persistent, and/or aperiodic. The first WTRU may receive configuration information indicating the one or more SRS sequences associated with the CLI (e.g., SRS-CLI-RSSI) measurement. For example, the configuration information may include an indication of one or more SRS sequences for the CLI measurements. For example, the first WTRU may receive the sequences used for SRS transmission via an index or indices in a MAC-CE and/or DCI to select from an RRC configured list. The SRS sequence may include an index and/or an identification (ID).

The first WTRU may perform one or more CLI measurements of the time and/or frequency resources. For example, the first WTRU may measure CLI (e.g., SRS-CLI-RSSI) in one or more of the configured time and frequency resources. For example, performing the one or more CLI measurements may include measuring the plurality of SRS transmissions in the same time resource and/or same frequency resources. For example, the first WTRU may perform an energy (e.g., and/or power) level measurement on the time and frequency resources. To perform the CLI measurements, the first WTRU may perform an energy level measurement and/or power level measurement on the time and frequency resources. For example, when two or more different SRS sequences are used (e.g., transmitted by a second and third WTRU), the first WTRU may derive the SRS-CLI-RSSI, for example, based on performing one or more measurements with one or more different SRS sequences and/or combining the one or more measurements using a pre-defined and/or pre-configured function. When one or more (e.g., multiple) different SRS sequences are used, for example, the first WTRU may determine the CLI measurements based on performing measurements with different SRS sequences and/or combining the measurements using a pre-defined and/or pre-configured function.

The first WTRU may compare the one or more CLI measurements to a threshold. The first WTRU may send an indication of the one or more CLI measurements. For example, if the measured CLI (e.g., SRS-CLI-RSSI) is higher than a first threshold and/or two or more different SRS sequences are used, the first WTRU may perform one or more of the following. For example, upon a determination that a measured CLI measurement of the one or more CLI measurements is greater than the threshold and a plurality of SRS sequences are used during the time and frequency resources, the first WTRU may determine an SRS sequence out of the plurality of SRS sequences and perform one or more of the following: send an indication of the SRS sequence, send a CLI associated with the SRS sequence, or send an indication of the one or more CLI measurements. The first WTRU may determine (e.g., and/or may attempt to determine) an SRS sequence among the SRS sequences (e.g., the SRS sequence with the highest CLI or one above a configured second threshold, the SRS sequence with the highest CLI (e.g., SRS-RSRP) and/or SRS sequence with a CLI (e.g., SRS-RSRP) above a configured third threshold. The first WTRU may report (e.g., if an SRS sequence is determined) one or more of: the determined SRS sequence (e.g., index or ID), the corresponding CLI, and/or the corresponding CLI (e.g., SRS-RSRP). The first WTRU may report the CLI measurement (e.g., SRS-CLI-RSSI). Upon a determination that a measured CLI measurement of the one or more CLI measurements is less than the threshold, the first WTRU may send an indication of the measured CLI measurements. For example, if the measured CLI (e.g., SRS-CLI-RSSI) is below the first threshold, the first WTRU may report the CLI (e.g., SRS-CLI-RSSI). Upon a determination that a measured CLI measurement of the one or more CLI measurements is greater than a threshold and a single SRS sequence was used during the time and frequency resources, and/or upon a determination that the first WTRU is unable to determine an SRS sequence among the plurality of SRS sequences, the first WTRU may perform one or more of the following: send an indication of one or more CLI (e.g., SRS-CLI-RSSI) measurements and/or send a request to a network node to provide the WTRU with another (e.g., new) measurement configuration with one or more SRS sequences and/or different SRS sequences. For example, if the measured CLI (e.g., SRS-CLI-RSSI) is higher than a first threshold and (e.g., only) one SRS sequence is used and/or if the first WTRU is unable to determine an SRS sequence among the SRS sequences, for example, the first WTRU may perform one or more of the following. The first WTRU may report the measured CLI (e.g., SRS-CLI-RSSI). The first WTRU may send a request to the gNB to provide the WTRU with a (e.g., new) measurement configuration with one or more (e.g., multiple) and/or different SRS sequences.

With respect to configuration of group-SRS measurement, for example, a first WTRU (e.g., a potential victim WTRU) may receive one or more configurations (e.g., via RRC, MAC-CE, DCI) to measure and/or report received signal strength (e.g., RSSI), for example, based on the one or more reference signals (e.g., SRS) received from one or more second WTRUs (e.g., two or more aggressor WTRUs). The WTRU may receive configurations on the time (window) and/or frequency resources to receive and/or measure one or more reference signals (e.g., SRS), where the reference signals may be transmitted from one or more second WTRUs at the same and/or overlapping time and/or frequency resources (e.g., group-SRS-transmission).

In examples, the first WTRU may receive configuration to perform the group-SRS measurement based on periodic, semi-persistent, and/or periodic configurations. In examples, the first WTRU may receive configuration information indicating the one or more reference signals (e.g., SRS sequences) that are configured to be transmitted in the group-SRS-transmission. For example, the first WTRU may be configured (e.g., via RRC, MAC-CE, DCI) with a list of SRS sequences (e.g., Zadoff-Chu sequences) and/or corresponding parameters (e.g., root index, cyclic shift, comb, hopping, etc.). The first WTRU may receive an indication (e.g., via MAC-CE, DCI) to select one of the SRS sequences from the list (e.g., via an index and/or indices).

The first WTRU may receive one or more configurations (e.g., via RRC, MAC-CE, DCI) on one or more threshold values corresponding to the measured parameters in group-SRS measurement. In examples, the one or more configurations may be used to determine the strength of a received signal to be higher or lower than one or more thresholds.

With respect to performing the group-SRS measurement, the terms SRS-RSSI and SRS-CLI-RSSI may be used interchangeably herein.

A first WTRU may be configured to measure the received signal's strength, energy, and/or power (e.g., SRS-CLI-RSSI) based on the configured time and/or frequency resources. In examples, the first WTRU may perform an energy (e.g., or power) level measurement based on the configured time and/or frequency resources. As such, for example, the first WTRU may measure the total received signal's strength, energy, and/or power that may be received from each second WTRUs (e.g., aggressor WTRUs) that are configured to transmit the configured reference signals (e.g., SRS) in the configured time and/or frequency resources.

Additionally or alternatively, a first WTRU may be configured with the one or more separate reference signals (e.g., at least two different SRS sequences) used for the group-SRS transmission (e.g., by the potential aggressor WTRUs). The first WTRU may use the configured reference signals (e.g., different SRS from different aggressor WTRUs) to measure the received power, energy, and/or strength. As such, for example, the first WTRU may measure the different SRS sequences and/or may determine the received SRS-CLI-RSSI by combining the measurements using a predefined and/or (pre)configured function.

With respect to reporting the group-SRS measurement, a first WTRU (e.g., potential victim WTRU) may determine that the measured SRS-CLI-RSSI is higher than a first threshold. In this case, if the WTRU is configured with two or more SRS sequences corresponding to one or more different WTRUs (e.g., more than one potential aggressor WTRUs), the first WTRU may determine to perform one or more of the following. In examples, a first WTRU may determine and/or attempt to detect one or more SRS sequence that is received with the highest power, energy, and/or strength (e.g., implying the aggressor WTRU and/or the SRS sequence that is causing the strongest interference for the first WTRU, e.g., CLI). The first WTRU may be configured with the one or more different SRS sequences that are used for the group-SRS transmission (e.g., by at least two potential aggressor WTRUs). The first WTRU may determine and/or detect the second WTRU that has transmitted the detected SRS. In examples, the first WTRU may determine the SRS sequence that is causing the highest interference (e.g., CLI). In examples, the first WTRU may determine the one or more SRS sequences that are causing the interference (e.g., CLI) which are higher than a second threshold. In examples, the first WTRU may determine the SRS-RSRP based on the detected SRS (e.g., the SRS with the highest CLI and/or the SRS with CLI above the second threshold). As such, for example, the first WTRU may determine the SRS with the highest measured SRS-RSRP, and/or the SRS for which the measured SRS-RSRP is higher than a third threshold. In examples, a first WTRU may report the determined SRS (e.g., index, indication, ID, SRI, etc., e.g., to a gNB) that the first WTRU has detected to cause the highest interference (e.g., CLI); the first WTRU may report the detected SRS for which the measured received energy, power, strength, etc. is higher than a second threshold; the first WTRU may report the determined SRS for which the measured SRS-RSRP is the highest; the first WTRU may report the determined SRS for which the measured SRS-RSRP is the higher than a third threshold; and so forth. Additionally or alternatively, the first WTRU may report the measured SRS-CLI-RSSI.

The first WTRU (e.g., potential victim WTRU) may determine that the measured SRS-CLI-RSSI is lower than the first threshold. As such, for example, the first WTRU may report the measured SRS-CLI-RSSI (e.g., to a gNB).

Additionally or alternatively, the first WTRU may determine that the measured SRS-CLI-RSSI is higher than a first threshold; however, the WTRU may determine and/or be indicated that (e.g., only) a single SRS is used by group of second WTRUs (e.g., potential aggressor WTRUs) in group-SRS-transmission (e.g., this may imply that the WTRU cannot detect and/or distinguish one or more different SRS sequences and/or aggressor WTRUs based on the group-SRS-transmission). As such, for example, the first WTRU may determine to report the measured SRS-CLI-RSSI.

The first WTRU may send a request (e.g., to the gNB) to receive one or more configurations for measuring the SRS from one or more other WTRUs (e.g., potential aggressor WTRUs) in a one-by-one SRS measurement. The configuration may include the SRS sequences and/or the time and/or frequency resources to measure the SRS-RSRP (e.g., accordingly).

With respect to group SRS transmission from one or more WTRUs over one or more shared resources, a WTRU (e.g., first WTRU) may be configured to transmit SRS based on at least a group indication. Such transmission may be used for the purpose of detecting a situation where the first WTRU would be causing high interference to a second WTRU. Such SRS transmission may be referred to as cross-link interference detection (CLID-SRS).

The terms group-SRS and CLID-RS may be used interchangeably herein.

The first WTRU may receive one or more configurations (e.g., via RRC, MAC-CE, DCI) for the transmission of CLID-SRS including transmission comb offset, number of ports, cyclic shift, time domain and/or frequency domain resource allocations, hopping parameters, spatial relation information, TCI state, whether the SRS is transmitted periodically, aperiodically and/or semi-persistently, power control parameters, and/or the like. Such configuration may be included as part of at least one CLID-SRS resource configuration and/or CLID-SRS resource set configuration.

The WTRU may be configured to reuse configuration of another SRS resource and/or SRS resource set, for one or more of the parameters herein. Such SRS may be referred to as a reference SRS. The identity of such reference SRS may be included in the configuration using its SRS resource ID and/or corresponding SRS resource set ID. The first WTRU may be configured with one or more TCI-state to be used and/or that may be used for the CLID-SRS transmission, e.g., as part of the CLID configuration. The first WTRU may receive one or more CLID-SRS resource configuration and/or resource set configuration.

The first WTRU may receive configuration of one or more group identity (e.g., group-ID) for the transmission of CLID-SRS (e.g., via RRC, MAC-CE, DCI). In examples, the first WTRU may belong to one or more WTRU groups. That is, the first WTRU may be configured and/or indicated (e.g., via RRC, MAC-CE, DCI) with more than one group-ID and/or a list of group-IDs for the groups that the first WTRU belongs to. The first WTRU may receive one or more separate configurations (e.g., via RRC, MAC-CE, DCI) for one or more (e.g., each) group (e.g., based on group-IDs), where the configuration may include the power backoff, timing advance, time and/or frequency resources to transmit CLID-SRS, etc. One or more (e.g., each) group-ID may be associated to one or more CLID-SRS resource configuration and/or resource set configuration. One or more (e.g., each) CLID-SRS resource configuration and/or resource set configuration may be associated to one or more group-ID.

In examples, a first WTRU may receive a trigger to perform a CLID-SRS transmission, where the trigger may be based on a configuration (e.g., periodic configuration, e.g., via RRC), trigger (e.g., semi-persistent and/or aperiodic configuration, e.g., via MAC-CE, DCI), and/or activation command (e.g., a flag indication from gNB, e.g., via DCI). As such, for example, the WTRU may receive the group-ID as part of the configuration, trigger, and/or activation command. The first WTRU may determine and/or verify if the configured, received, and/or indicated group-ID is included in the list of group-IDs that is configured and/or indicated to the first WTRU.

In case the first WTRU determines that the first WTRU belongs to the configured, triggered, and/or activated group of WTRUs (e.g., based on the group-ID), for example, the first WTRU may transmit CLID-SRS in the configured and/or indicated time and/or frequency resources and/or based on received group SRS transmission configurations and/or associated CLID-SRS resource configuration(s) and/or resource set configuration(s).

The WTRU may determine applicable TCI state for the transmission of CLID-SRS based on one or more of the following. The WTRU may determine applicable TCI state for the transmission of CLID-SRS based on the latest signaled TCI state, e.g. in case of a unified TCI state. The WTRU may determine applicable TCI state for the transmission of CLID-SRS based on indication of a coresetPoolIndex parameter as part of CLID-SRS resource (set) configuration corresponding to the indicated group-ID. The WTRU may determine applicable TCI state for the transmission of CLID-SRS based on indication of whether to use first or second TCI state in signaling, where the first and/or second TCI states may be configured as part of CLID-SRS resource (set) configuration. The signaling may be the signaling that triggers transmission of CLID-SRS.

The WTRU may determine transmission power and/or timing advance based on determined applicable TCI state. Additionally or alternatively, the WTRU may determine transmission power based on power control parameters configured as part of the CLID-SRS resource (set) configuration.

The signaling triggering transmission of CLID-SRS may include additional information for the transmission of CLID-SRS, such as one or more of: an indication of a power offset to apply to the transmission power (e.g., such power offset may be applied to a transmission power calculated using another solution), and/or an indication of a timing offset to apply to the transmission timing determined using another solution, e.g. the transmission timing associated to applicable TCI state.

What is claimed is:

1.-20. (canceled)

21. A first wireless transmit/receive unit (WTRU) comprising:
a memory and a processor, wherein the processor is configured to:
receive configuration information associated with one or more sounding reference signal (SRS) resources;
receive an indication to receive and measure an SRS transmission in an SRS resource of one or more SRS resources and measure cross link interference (CLI),
wherein the SRS resource is associated with a first time;
receive a first timing offset associated with the SRS transmission;
determine a time window to receive the SRS transmission based on the first time associated with the SRS resource and the first timing offset;
receive the SRS transmission at a second time, wherein the second time is within the time window, wherein the SRS transmission is transmitted by a second WTRU;
determine a second timing offset based on the second time and the first time;
perform one or more measurements on the SRS transmission; and
send a message to a network node, wherein the message comprises an indication of the one or more measurements and the second time offset.

22. The first WTRU of claim 21, wherein the first timing offset is a timing advance (TA) for reception of the SRS transmission from the second WTRU that is separate from a TA that the WTRU uses for transmission of an uplink (UL) transmission.

23. The first WTRU of claim 21, wherein the first timing offset is a delta offset value, wherein the delta offset value indicates a number of timing advance (TA) instances with respect to the uplink (UL) transmission TA value of the first WTRU.

24. The first WTRU of claim 21, wherein the one or more measurements comprise WTRU-to-WTRU CLI based on the received SRS transmission.

25. The first WTRU of claim 24, wherein the WTRU-to-WTRU CLI comprises SRS-reference signal received power (SRS-RSRP) or CLI-received signal strength indicator (CLI-RSSI) in uplink (UL) or downlink (DL) subbands, respectively.

26. The first WTRU of claim 21, wherein the processor is further configured to:
receive SRS repetition information; and
measure repeated SRS transmission based on the SRS repetition information.

27. The first WTRU of claim 21, wherein the determination of the first timing offset associated with the SRS transmission is based on reception of the timing offset associated with the SRS transmission, wherein the first timing offset is received via downlink control information (DCI) or medium access control control element (MAC CE).

28. The WTRU of claim 21, wherein the processor being configured to perform the one or more measurements comprises the processor being configured to perform one or more aperiodic measurements based on one or more aperiodic SRSs.

29. The first WTRU of claim 21, wherein the second timing offset is determined based on when the first WTRU receives the SRS transmission in the time window and the time of the SRS resource.

30. The first WTRU of claim 21, wherein the indication of the one or more measurements comprises an indication of a measured cross-link interference (CLI) value.

31. A method performed by a first wireless transmit/receive unit (WTRU), the method comprising:
receiving configuration information associated with one or more sounding reference signal (SRS) resources;
receiving an indication to receive and measure an SRS transmission in an SRS resource of one or more SRS resources and measure cross link interference (CLI), wherein the SRS resource is associated with a first time;
receiving a first timing offset associated with the SRS transmission;
determining a time window to receive the SRS transmission based on the first time associated with the SRS resource and the first timing offset;
receiving the SRS transmission at a second time, wherein the second time is within the time window, wherein the SRS transmission is transmitted by a second WTRU;
determining a second time offset based on the second time and the first time;
performing one or more measurements on the SRS transmission; and
sending a message to a network node, wherein the message comprises an indication of the one or more measurements and the second time offset.

32. The method of claim 31, wherein the first timing offset is a timing advance (TA) for reception of the SRS transmission from the second WTRU that is separate from a TA that the first WTRU uses for transmission of an uplink (UL) transmission.

33. The method of claim 31, wherein the first timing offset is a delta offset value, and wherein the delta offset value indicates a number of timing advance (TA) instances with respect to the uplink (UL) transmission TA value of the WTRU.

34. The method of claim 31, wherein the one or more measurements comprise WTRU-to-WTRU CLI based on the received SRS transmission.

35. The method of claim 34, wherein the WTRU-to-WTRU comprises SRS-reference signal received power (SRS-RSRP) or CLI-received signal strength indicator (CLI-RSSI) in uplink (UL) or downlink (DL) subbands, respectively.

36. The method of claim 21, wherein the method further comprising:
receiving SRS repetition information; and
measuring repeated SRS transmission based on the SRS repetition information.

37. The method of claim 21, wherein the determination of the first timing offset associated with the SRS transmission is based on reception of the first timing offset associated with the SRS transmission, wherein the first timing offset is received via downlink control information (DCI) or medium access control control element (MAC CE).

38. The method of claim 31, wherein performing the one or more measurements comprises performing one or more aperiodic measurements based on one or more aperiodic SRSs.

39. The method of claim 31, wherein the second timing offset is determined based on when the first WTRU receives the SRS transmission in the time window and the time of the SRS resource.

40. The method of claim 31, wherein the indication of the one or more measurements comprises an indication of a measured cross-link interference (CLI) value.
